(19) United States
(12) Patent Application Publication
(10) Pub. No.: US 2010/0228699 A1
(43) Pub. Date: Sep. 9, 2010

(54) SYSTEM AND METHOD FOR INTERACTING WITH CLINICAL TRIAL OPERATIONAL DATA

(75) Inventors: Robert C. Webber, Sammamish, WA (US); Jeremiah Rehm, Kirkland, WA (US); Volodymyr Trubachov, Bellevue, WA (US)

Correspondence Address: MILLER NASH LLP, 601 UNION STREET, SUITE 4400, SEATTLE, WA, 98101-2352, US

(73) Assignee: TRANSENDA INTERNATIONAL, LLC, Bellevue, WA (US)

(21) Appl. No.: 12/785,354

(22) Filed: May 21, 2010

Related U.S. Application Data
(63) Continuation-in-part of application No. 12/214,763, filed on Jun. 20, 2008.
Application No. 12/214,763 is a continuation-in-part of application No. PCT/US09/48027, filed on Jun. 19, 2009.

(51) Int. Cl. G06F 17/30

(52) U.S. Cl. 707/622; 707/783; 707/E17.005; 707/610

(57) ABSTRACT

A method and system for exchanging clinical trial operational data by using a centralized shared server system connected to a plurality of shared servers. The system and method manage a plurality of clinical trial-related applications by creating a plurality of tables stored within the shared database of the shared database system connected to a centralized shared server system within a virtual network for updating and sharing among clinical trials. The current system and method allow exchanging clinical trial operational data between a centralized shared server system and a plurality of shared servers to delegate responsibility to other clinical trial organization users for producing subsets of clinical trial operational data with limited data access rights. The current system and method allow assigning data access rights to other clinical trial organizations by configuring the at least one other clinical trial organization as either a producer or a consumer of the clinical trial operational data for limiting access to the at least one table with the clinical trial operational data by the at least one other clinical trial organization. The current system and method allow each business partner to manage the assigned responsibilities by using existing clinical trial management systems applications and to maintain views of other clinical trial organizations activities of clinical trial operational data subject to assigned data access rights.

### CROSS-REFERENCE TO RELATED APPLICATION

This present application is a continuation-in-part of U.S. patent application Ser. No. 12/214,763 filed Jun. 20, 2008. This present application is also a continuation-in-part of, and claims priority under 35 U.S.C. Section 120 to PCT Application PCT/US09/48027 filed Jun. 19, 2009. The present application is based on and claims priority from these applications, the disclosures of which are hereby expressly incorporated herein by reference.

### COPYRIGHT NOTICE

A portion of the disclosure of this patent document contains material that is subject to copyright protection. The copyright owner has no objection to the facsimile reproduction of the patent disclosure as it appears in the Patent and Trademark Office patent files or records, but otherwise reserves all copyright rights whatsoever.

### REFERENCE TO A COMPUTER PROGRAM

A computer program listing is submitted on a compact disc (CD-R), and the material (including Code.txt that contains the following software components: Part A, Part B, Part C, Part D, and Part E) on the compact disc is included in the patent application and hereby incorporated by reference in its entirety.

The single compact disc (submitted in duplicate) includes files (Code.txt, Jun. 5, 2008, 277 KB) with portions of exemplary computer code implementing various embodiments of the present invention and exemplary data definition specifications for users.

The single compact disc (submitted in duplicate) includes the following files:

| | | | Creation |
|---|---|---|---|
| File Title | File Name | Size | Date |
| Access Module Code | A_code_accessmod.txt | 34 KB | Jun. 5, 2008 |
| Discovery Module Code | B_code_discovery.txt | 8 KB | Jun. 5, 2008 |
| Data Source Module Code | C_code_datasource.txt | 59 KB | Jun. 5, 2008 |
| Linked Discovery Module | D_code_linked_discovery.txt | 13 KB | Jun. 5, 2008 |
| Code | | | |
| Synchronization Module Code | E_code_synchronization.txt | 163 KB | Jun. 5, 2008 |

These files include portions of exemplary computer codes implementing various embodiments of the present invention and data definition specifications for users.

### TECHNICAL FIELD

This specification describes generally a system with a centralized repository database for integrating, viewing, updating, and standardizing clinical trial-related information from various clinical trial-related applications. More particularly, the specification describes a system and method for access, review, management, retrieval, configuration, modification, analysis, and standardization of clinical trial operational data for consistency and reusability.

### BACKGROUND OF INVENTION

A clinical trial or clinical study (hereinafter referred to as “clinical trial”) is a research study designed to test the safety and/or effectiveness of “products” such as drugs, devices, diagnosis, procedures, treatments (e.g. treatments for diseases), and/or preventive measures in humans. Clinical trials are conducted using a process (hereinafter referred to as a “clinical trial process”) that may be divided into categories or “phases” (hereinafter referred to as “clinical trial phases”). Typically, a clinical trial process can extend over a period of time ranging from months to years.

In order to conduct extensive clinical trials for evaluating new products, numerous “clinical trial organizations” (entities involved in the clinical trial) including sponsors, contract research organizations (CROs), investigator sites, clinical sites, development teams, call centers, laboratories, suppliers, design engineering teams, manufacturers, regulatory agencies, and other contributors and participants that are involved in the clinical trial process. Sponsors typically refer to pharmaceutical, medical device, or biotechnology companies that own the rights to the new product under the clinical trial and are responsible for submitting an investigational new drug (IND) to the Federal Drug Administration (FDA). CROs are clinical trial service companies that may assist in gathering and managing clinical trial processes. Investigator sites conduct clinical trials at which the product is administered to the patients, observed, and recorded for the sponsors.

Clinical trials involve retrieving, analyzing, and managing the collaboratively obtained clinical trial data (hereinafter referred to as “clinical trial data”) from various clinical trial organizations collected during the clinical trial process before an IND can be submitted to the FDA. As will be discussed in detail, clinical trial data includes both “experimental data” and “operational data,” although the primary focus to date has been on the experimental data. For clinical trial data, there are basically two types of data that are distinguishably different and can be treated separately. First, the clinical trial data consists of clinical or research data, which is information collected and recorded during a clinical trial that provides the basis of an IND's claim for significance to prove efficacy and safety of a new product (also referred to as “experimental data”). Second, the clinical trial data also consists of clinical trial process data that is information used by the clinical trial-related applications and human subjects to execute the clinical trial process (also referred to as “clinical trial operational data” or “operational data”).

An analogous example includes the manufactured product as opposed to the manufacturing process in making the manufacturing product. With more efficient, reusable, manageable, repeatable, and useful manufacturing processes, it is easier and more efficient to obtain the final manufacturing product or clinical trial data/results. The operational data is not required to be submitted to the FDA as the experimental data. However, the operational data is generally available and useful to demonstrate a well-executed clinical trial and not just to assist in day-to-day operations and clinical trial planning. While the operational data is not directly associated with proof of efficacy and safety of the product under the clinical trial, the operational data is highly useful for the efficiency of the clinical trial in terms of cost and duration.

Each clinical trial process for a clinical trial must create and follow a clinical trial standard protocol that provides a standard method of conduct in collecting experimental data for evaluating the efficacy and safety of the new product. Investigator sites at which the clinical trial protocol will be executed are selected, and patients are recruited. The experimental product is administered to selected patients at the investigator sites when patients visit. After collecting ample experimental data, the experimental data is statistically analyzed for significance to prove efficacy and safety of the product. The experimental data is in the IND to be submitted to the FDA. Sponsors typically are responsible for submitting the IND to the FDA. The IND supports commercialization of a product based on the experimental data collected over the duration of the different clinical trial phases. The experimental data contained in the IND typically provides evidence of and supports safety and efficacy of the new product upon which the experimental data was collected through the clinical trial process.

In the past decade, management of experimental data from clinical trials has vastly improved in the clinical trial industry, from organization of paper copies to the use of computer technologies for managing electronic copies that make the clinical trial process faster and less expensive. Some of the examples of the clinical trial software applications that have been developed by vendors automate segmented portions of the clinical trial process and are commonly adopted in the clinical trial process, including Electronic Data Capture (EDC), Clinical Trial Management System (CTMS), safety management software applications, eSubmission software applications, and other applications focusing on certain aspects of the clinical trial.

EDC refers to a computer system that captures and records clinical trial data from clinical trial subjects that are used within the domain of each individual investigator or participating site. The EDC applications attempt to catch and rectify user input errors at the time the clinical trial data is being input and recorded. The limitation, however, is that clinical trial data captured using the EDC applications are not shared or integrated by other sites and clinical trial organizations, and may not be readily available to the knowledge worker managing the clinical trial. The CTMS applications are software packages that improve the efficiency and effectiveness of the overall clinical trials managing the overall clinical trial management processes by structuring, maintaining, making available clinical trial data, managing workflow, and providing operational reports. Safety management software applications are software packages for electronically formatting and sending to the FDA reports pertaining to adverse reactions to a new product during a clinical trial that are required to be reported to the FDA. eSubmission software applications are software packages available to assist with generating IND documents for submission and to better facilitate electronic submission of the IND to the FDA.

Other than the aforementioned clinical trial software applications, enterprise software applications such as customer relationship management systems (CRM), manufacturing execution systems (MES), financial systems, and other applications are additionally maintain and integrate the vast amount of clinical trial data such as operational data for the clinical trial processes. The CRM applications are typically used for maintaining contact information for sites, locations, and people other than clinical trial subjects. The MES applications are implemented for managing information related to drug handling and shipments. Clinical trial software applications are provided by either one clinical trial software vendor or more often than not, are provided by multiple clinical trial software vendors. Because the multiple vendors offer only their clinical trial software applications and store clinical trial data in various locations, integration and sharing of clinical trial data is a major challenge.

Known clinical trial data integration methods such as point-to-point interconnection and common data repository methods are used to overcome the integration and information-sharing problem; however, they have severe limitations. The point-to-point interconnection method implements a unique software program developed to exchange clinical trial data between two specific clinical trial software applications, therefore referred to as point-to-point communication between the clinical trial software applications. Since the clinical trial software applications may be developed by different vendors, congruity of different computer protocols is more difficult. Clinical trial organizations within the industry attempted to standardize the different computer data formats. Examples of such data representation standards include Clinical Data Interchange Consortium (CDISC), Operational Data Model (ODM) based upon Extensible Markup Language (XML).

These data representation standards have been extremely slow in terms of clinical trial industry adoption because a number of unique program interfaces are required for their implementation using a point-to-point integration model. Furthermore, the number of possible interconnections using a point-to-point integration method between N nodes is proportional to the square of N (Formula for interconnection of N nodes is N*(N−1)/2). For example, point-to-point interfaces of eight (8) clinical trial software applications potentially require twenty-eight (28) unique interconnections. There are possibly one hundred and twenty (120) interconnections for integrating sixteen (16) different clinical trial software applications. Therefore, the point-to-point integration has severe limitations by requiring a great number of specially developed interfaces for sharing and communicating experimental data and operational data.

The common data repository is a database structure for also interconnecting clinical trial data between the various clinical trial software applications. The primary limitation of the common data repository is that two or more vendors are required to agree on a specific format and layout, also referred to as a schema, for the common data repository. The vendors also must agree on the meaning of each data item defined within the specific trial. The vendors must also agree on the access protocol to read and modify the experimental and operational data to physically access the common data repository database, whether through Web services or the local area networks. The secondary limitation or problem with the common data repository database is that when one of the vendors changes the data schema or data type, the other clinical trial software applications need to be modified so that the integrated clinical trial software applications conform to the new specific format and schema. These inherent limitations are a major obstacle to integrating and sharing clinical trial data from various clinical trial software applications.

The prevailing standard for interchange of clinical trial data is a set of XML-based data formats that are defined by the Clinical Data Interchange Standards Consortium (CDISC). The standard applicable to the clinical trial data collected during a clinical trial is the CDISC Operational Data Model (ODM). CDISC ODM can be used to define a data structure or data schema and to exchange clinical trial data between the different clinical trial software applications that are based upon different computing platforms. For example, a single XML document that includes patient visit information recorded during the clinical trial can reside as an XML document within a database and can be exchanged within a message between different computers. For optimal flexibility, CDISC ODM organizes clinical trial data in the groups of “Items” for individual data fields (e.g. blood pressure reading), “Item Group” for a logical collection of items, “Forms” for a logical collection of items and item groups that may or may not correspond directly to forms used during a clinical trial, “Clinical Trial Event” for a patient visit or some other type of data collection event, “Subject” for a patient participating in a clinical trial, and “Annotation” for a comment applied to the items previously mentioned.

Historically, the experimental data has been viewed as the more important data because the scientists and industry focused primarily on the outcome and management of the experimental data. The first and most prevalent clinical trial software application, EDC, is primarily focused on obtaining and cleaning the experimental data. The EDC applications were challenged to also manage operational data on an administrative level to run a clinical trial and to collect experimental data. Other clinical trial software applications emerged focusing on fragmented sections of the entire clinical trial. As a result of the experimental data-centric view, the interchange of clinical trial data problem has primarily focused on solving exchange of experimental data and resulting in standards such as CDISC to account for the infinite types and variations of experimental data collected during a clinical trial. This experimental data-centric view has resulted in a confusing clinical trial specific configuration of clinical trial software applications where the operational data may be maintained and managed in any of the clinical trial software applications.

CDISC contains a very small set of reserved XML tags for basic operational data function other than clinical trial experimental data that are limited to contact information (such as “Clinical Trial Name,” “Protocol Name,” and “User Information”) for anyone involved in the clinical trial on a limited operational basis. However, the CDISC standard does not provide context for the balance of the operational data. CDISC is further hampered in terms of facilitating interchangeability of operational data due to lack of semantics and overly flexible data definitions that are intended to address experimental data rather than operational data. Consequently, any party participating in a clinical trial that needs to utilize a CDISC ODM file is required to learn the clinical trial specific context and meaning in which the operational data is interpreted through another document, or by modifying and replacing operational data definitions during the clinical trial, making it extremely cumbersome and inefficient. Known solutions are severely limited because they do not account for definitions beyond the typical level defined within CDISC ODM like “Clinical Trial Name,” “Protocol Name,” and “User Information”.

Accordingly, there is a need to centrally integrate and manage operational data without lumping experimental data with operational data from clinical trials and to expand the operational data functionality. Moreover, there is a need for a system and method for expanding the functionality of operational data. Further, there is a great need for sharing operational data among the various clinical trial software applications as well as other clinical trial-related applications. More-efficient sharing of data would optimize performance and management of operational data while providing flexibility by allowing easy viewing, defining in terms of syntax as well as semantics, accessing operational data without having to agree on data schema or types every time a clinical trial software application modifies its specific format, expanding data definitions, and reusing operational data between different clinical trials. Since the operational data is a relatively small subset of the data types within a trial, new methods can be constructed that would not be feasible within the context of all clinical trial data. Such a system would provide the capability to manage operational data and data definitions, consistency, with data security, and reusability of operational data. Such a system would also allow the auditing of operational data transactions, and create easy access for users.

### BRIEF SUMMARY OF THE INVENTION

The current system and method allow interacting with clinical trial operational data for easy accessibility, reusability of software, and centralized use of operational data and software for conducting clinical trials based on semantics as well as syntax for consistency.

The current system and method manage a plurality of clinical trial-related applications by creating a plurality of tables stored within the shared database for updating and sharing between clinical trials. The tables are organized by a clinical trial process structure, and each table contains predefined data field identifiers associated only with operational data as opposed to experimental data.

The current method for interacting with clinical trial operational data allows a plurality of clinical trial-related applications to communicate with a shared database system for adding, deleting, and/or modifying operational data in the tables stored in the shared database. The operational data is added or deleted in a row or rows under the predefined data field identifiers in the column headings portion.

The shared database system has a shared database storing a plurality of tables and a computer program for communicating with the plurality of shared server interacting applications in updating the plurality of operational data associated with the predefined data field identifiers within the plurality of tables.

The shared database system can optionally connect with a plurality of linked server interacting applications via a plurality of linked servers to interact with the shared server. The shared server is comprised of a shared database having a plurality of tables, a computer program for executing instructions (executable instructions) to synchronize with at least one linked server of the plurality of linked servers, a linked server database for synchronizing and storing the plurality of tables with the plurality of operational data received from the shared server after synchronization, a linked server computer program for executing instructions to synchronize with the shared server, and a configuration user interface for an administrator to set configuration parameters between the shared server and at least one of the plurality of linked servers.

The shared database system and method optionally store approver information in the shared database, review the approver information related to at least one change in the operational data, contact at least one approver with the at least one change in the operational data, store approver response information regarding the at least one change in the operational data, send the approver response information regarding the at least one change in the operational data in an acknowledgment message to the plurality of linked server interacting applications, and generate the approver information associated with each operational data in table views.

The current system and method configure the plurality of clinical trial-related applications associated with the plurality of operational data as a producer or a consumer of the operational data to maintain consistency among the plurality of clinical trial-related applications involved in a specific trial while maintaining a consistent data format for reusability of the clinical trial-related applications that utilize the operational data.

The current system and method provide a centralized clinical trial operational data hub with transactional acknowledgment recording and sequence verification. The current system and method also provide a centralized clinical trial operational data hub with audit trail information and reporting.

A method described herein for exchanging clinical trial operational data among a plurality of clinical trial organizations using a plurality of shared servers connected to a centralized shared server system of a shared database system includes the steps of: allowing a first clinical trial organization to access the centralized shared server system; receiving from the first clinical trial organization an assignment of data access rights associated with at least one clinical trial operational data to at least one other clinical trial organization for at least one clinical trial from the centralized shared server system; generating at least one table with the assigned data access rights associated with the at least one clinical trial operational data for the at least one clinical trial in a first shared server; communicating the assigned data access rights associated with the at least one clinical trial operational data for the at least one clinical trial to the at least one other clinical trial organization; and allowing the at least one other clinical trial organization to access the at least one table associated with the at least one clinical trial operational data, the access limited by the assigned data access rights; wherein the shared database system continuously provides updated clinical trial operational data accessible by any of the at least one other clinical trial organization from associated at least one shared server in accordance with the assigned data access rights associated with the at least one clinical trial operational data. The method may also include the step of automatically synchronizing the at least one clinical trial operational data based on common data definitions based on the data access rights associated with the clinical trial operational data within the plurality of shared servers. The step of allowing a first clinical trial organization to access the centralized shared server system may include the steps of: providing a configuration user interface of the centralized shared server system; and receiving the data access rights associated with the at least one clinical trial operational data from the configuration user interface. The step of receiving may further include configuring the at least one other clinical trial organization according to the assignment of data access rights as either a producer or a consumer of the clinical trial operational data for limiting access to the at least one table with the clinical trial operational data by the at least one other clinical trial organization. The step of generating may include the steps of: sending the assigned data access rights associated with the at least one clinical trial operational data to the first shared server; and displaying at least one table view on a user interface of the assigned data access rights associated with the at least one clinical trial operational data of the at least one other clinical trial organization in the first shared server. The step of communicating further includes continuously synchronizing the centralized shared server system with the plurality of shared servers of the plurality clinical trial organizations based on a synchronization interval configured with any updated assigned data access rights associated with the at least one clinical trial operational data for the at least one clinical trial.

A shared database system described herein is for exchanging clinical trial operational data using a plurality of shared servers connected to a centralized shared server system. The shared database system includes: a synchronizing computer application stored in a computer-readable storage medium of the centralized shared server system, the synchronizing computer application for synchronizing the clinical trial operational data between the centralized shared server system and the plurality of shared servers; a plurality of shared databases stored in a computer-readable storage medium of at least one of the plurality of shared servers, each shared database having a plurality of tables stored therein, wherein each table of the plurality of tables is organized by the clinical trial operational data and each table of the plurality of tables contains predefined data field identifiers associated with the clinical trial operational data for at least one clinical trial; and a communications computer program stored in a computer-readable storage medium of at least one of the plurality of shared servers, the communications computer program being in communication with a plurality of shared server interacting applications to update the clinical trial operational data associated with the predefined data field identifiers for the at least one clinical trial in the plurality of tables. Preferably the synchronizing computer application is accessible via a configuration user interface for configuring data access rights of at least one other clinical trial organization as either a producer or a consumer of the clinical trial operational data for limiting access to the clinical trial operational data. Preferably the configuration user interface allows configuring a synchronization interval for synchronizing the clinical trial operational data associated with the data access rights with the plurality of shared servers. Preferably each table of the plurality of tables contains the predefined data field identifiers in a column headings portion and the clinical trial operational data are in rows that are populated under the predefined data field identifiers for the at least one clinical trial. Preferably the communications computer program associates each of the clinical trial operational data with the predefined data field identifiers within a table, wherein manipulation of clinical trial operational data is selected from the group consisting of addition, deletion, and modification of rows under the predefined data field identifiers within the table.

A computer-readable storage medium described herein has executable instructions written as computer-readable program code for causing a centralized shared server system to exchange clinical trial operational data with a plurality of shared servers connected to a plurality of shared server interacting applications. The executable instructions cause the centralized shared server system to: connect with the plurality of shared servers; assign data access rights associated with at least one clinical trial operational data to at least one other user, the data access rights and the clinical trial operational data being input by a first user using a shared server to interact with a configuration user interface of the centralized shared server system; update at least one table in a shared database with the data access rights associated with the at least one clinical trial operational data in the shared server of the first user; send the assigned data access rights associated with the at least one clinical trial operational data to the plurality of shared servers connected to the plurality of shared server interacting applications; and store at least one table in the shared database with at least one change in the clinical trial operational data in the shared server; wherein a shared database system provides updates of the data access rights associated with the at least one clinical trial operational data input by other users from the centralized shared server system to the plurality of shared servers. The executable instructions preferably cause the centralized shared server system to assign data access rights further causing the centralized shared server system to configure the plurality of shared servers for the at least one other user as a producer or a consumer of the clinical trial operational data for limiting access to the clinical trial operational data. The executable instructions preferably cause the centralized shared server system to exchange the clinical trial operational data updated by the plurality of shared server interacting applications with the plurality of shared servers. The executable instructions preferably cause the centralized shared server system to configure the plurality of shared servers interacting with the plurality of clinical trial operational data as a producer or a consumer of the clinical trial operational data to limit access to the plurality of clinical trial operational data. The executable instructions preferably cause the centralized shared server system to provide a central operational data hub with information in a readily accessible format from the perspective of each clinical trial organization. The executable instructions preferably cause the centralized shared server system to delegate responsibility to other users for producing subsets of clinical trial operational data with limited data access rights.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

The accompanying drawings, which are incorporated in and constitute a part of this specification, illustrate various exemplary embodiments.

FIG. 1 is a schematic diagram illustrating an embodiment of a shared database system for interacting with clinical trial operational data using a plurality of shared server interacting applications.

FIG. 2 is a schematic diagram illustrating another embodiment of a shared database system for interacting with clinical trial operational data using a plurality of shared server interacting applications and a plurality of linked server interacting applications via a plurality of linked servers.

FIG. 3 is a schematic diagram illustrating another embodiment of a shared database system for interacting with clinical trial operational data using a plurality of shared server interacting applications and a plurality of linked server interacting applications through a linked server.

FIG. 4 is a schematic diagram illustrating another embodiment of the detailed shared database system with its components for interacting with clinical trial operational data using a plurality of shared server interacting applications.

FIG. 5 is a schematic diagram illustrating another embodiment of the detailed shared database system with its components for interacting with clinical trial operational data and synchronizing with a linked server.

FIG. 6 is a schematic diagram illustrating another embodiment of the detailed shared database system for interacting with clinical trial operational data with its components, including a discovery module and synchronizing with a linked server.

FIG. 7 is a flow chart illustrating a method of updating operational data through a shared server interacting application in another exemplary embodiment.

FIG. 8 is a flow chart illustrating a method of optionally approving changes with approvers before updating the operational data with changes in another exemplary embodiment.

FIG. 9 is a flow chart illustrating a method of configuring the shared database system and optionally selecting a discovery function carried out by an administrator in another exemplary embodiment.

FIG. 10 is a flow chart illustrating a method of updating operational data between a linked server and a shared server in another exemplary embodiment.

FIG. 11 is a flow chart illustrating a method of using the discovery function in another exemplary embodiment.

FIG. 12 is an exemplary table view illustrating updating operational data in tables.

FIG. 13 is an exemplary approver table view associating a plurality of data with a plurality of approvers.

FIG. 14 is a screen shot illustrating a configuration user interface for an administrator to set configuration parameters in another exemplary embodiment.

FIG. 15 is table view of an exemplary permissions table illustrating a plurality of clinical trial-related applications and a plurality of data fields configured as either a producer or a consumer.

FIG. 16 is a schematic showing an exemplary embodiment of a message flow between a shared server interacting application and a shared server.

FIG. 17A is a schematic diagram of an exemplary simplified embodiment of a virtual network using a centralized shared server system.

FIG. 17B is a screen shot of an exemplary common data view.

FIG. 17C is a schematic diagram of an exemplary simplified embodiment of a virtual network using a centralized shared server system interconnecting with a plurality of sponsors and CROs.

FIG. 18A is a schematic diagram of an exemplary embodiment of a virtual network for centralized clinical trial management with a sponsor focus.

FIG. 18B is a schematic diagram of an exemplary embodiment of a virtual network for centralized clinical trial management with a CRO focus.

FIG. 19 is a schematic diagram of an exemplary embodiment of a virtual network interconnecting at least one sponsor with at least two CROs.

FIG. 20 is a schematic diagram of a plurality of clinical trial organizations for exemplary clinical trial studies involving multiple clinical sites.

FIG. 21A is a chart showing Sponsor A's view of BV-073 subject enrollment.

FIG. 21B is a chart showing Sponsor B's view of BV-057 subject enrollment.

FIG. 21C is a chart showing CRO A's view of subject enrollment only for studies for which CRO A has responsibility.

FIG. 21D is a chart showing CRO B's view of BV-073 subject enrollment for which CRO B has responsibility.

### DETAILED DESCRIPTION OF THE INVENTION

The invention described herein is directed to a system and method for accessing, sharing, reviewing, managing, retrieving, configuring, modifying, analyzing, integrating, viewing, updating, standardizing, or otherwise “interacting” with “clinical trial data” (and clinical trial “operational data” in particular) from various “clinical trial-related applications” and linked servers for easy accessibility, reusability, standardization, consistency, and integration.

Before describing the invention and the figures, some of the terminology should be clarified. Please note that the terms and phrases may have additional definitions and/or examples throughout the specification. Where otherwise not specifically defined, words, phrases, and acronyms are given their ordinary meaning in the art. Exemplary embodiments may be better understood with reference to the drawings, but these embodiments are not intended to be of a limiting nature.

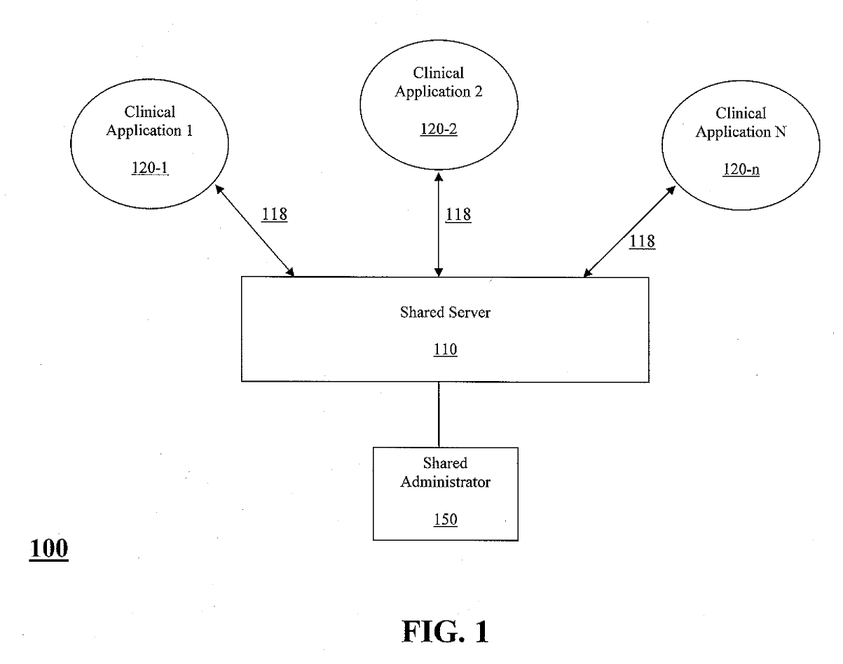

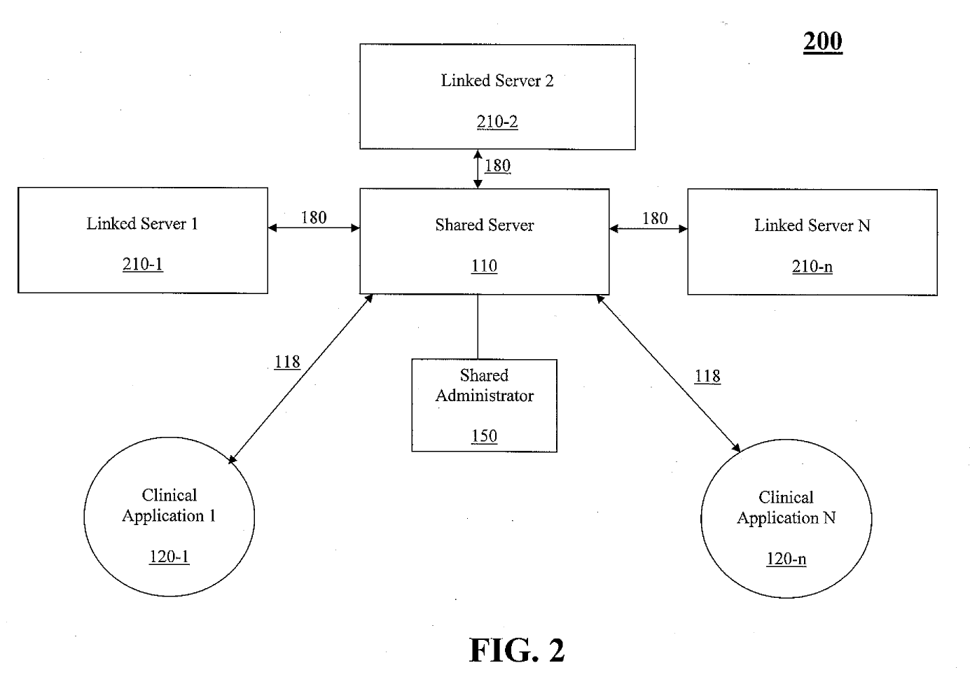

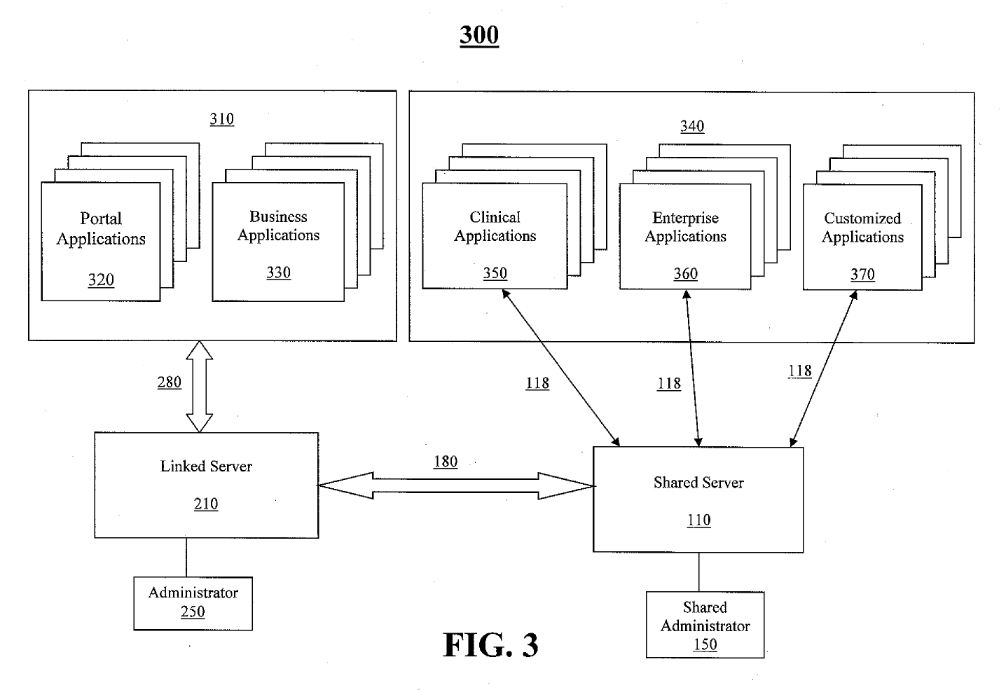

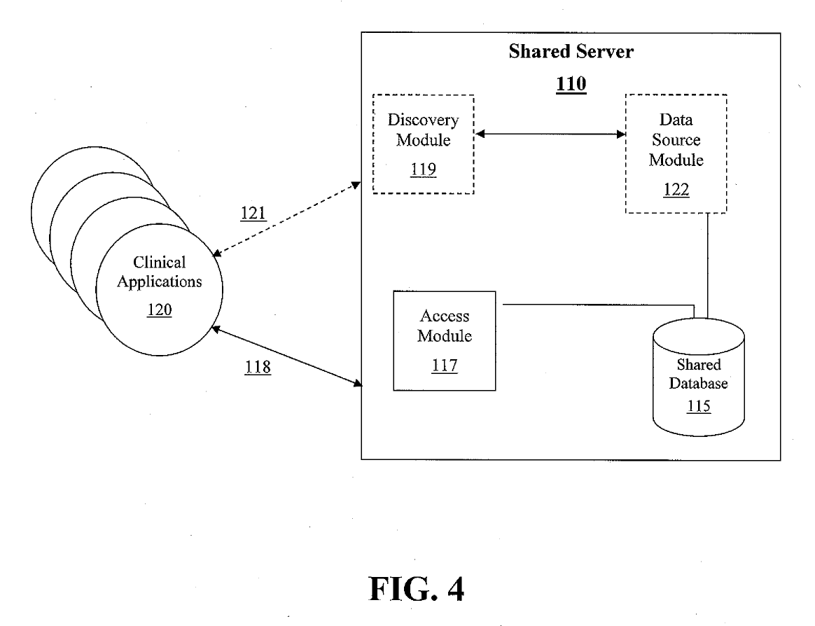

As used herein, “system” describes the combination of hardware and software to accomplish the tasks described herein. Exemplary systems are shown as system 100 of FIG. 1, system 200 of FIG. 2, and system 300 of FIG. 3. The core of the system is a shared server 110 that may be any type of database that has a database repository (shown in FIGS. 4-6 as shared database 115) for storing and saving operational data in a table format.

The terms “data connection,” “communication protocol,” and “interface technology” are interrelated terms. A “data connection” is the channel by which software communicates (shares or transfers data) with other software. Exemplary data connections (shown in the figures as 118, 180, 280, 1180, 1182, 1184) include, alone or in any suitable combination, a telephony network, a local area network (LAN), a wide area network (WAN), a dedicated intranet, wireless LAN, the Internet, an intranet, an extranet, a wireless network, a bus, or any other electronic or optical communication mechanisms for data interchange. Further, any suitable combination of wired and/or wireless components and systems may constitute data connections. Data connections (118, 180, 280, 1180, 1182, and 1184) may be implemented using bi-directional, uni-directional, or dedicated communication links. Data connections (118, 180, 280, 1180, 1182, and 1184) for sharing operational data may also use standard communication protocols. The term “communication protocol” can be thought of as the agreed upon method by which data or data signals is/are transferred. Exemplary communication protocols include Simple Object Access Protocol (SOAP), Representational State Transfer (REST), Remote Procedure Call (RPC), Distributed Component Object Model (DCOM), Web Services (WS), Transmission Control Protocol/Internet Protocol (TCP/IP), Hypertext Transfer Protocol (HTTP), and Remote Procedure Call (RPC). The term “interface technology” uses both the data connections and the communication protocol to interconnect software. Services-oriented architecture (SOA) is one example of an interface technology that is a standardized architecture to support the connection of software and applications for the purpose of sharing of data. By using SOA, the system's architectural style is built on creating and utilizing business processes by offering services.

“Clinical trial-related applications” refers generally to software applications that interact with the systems 100, 200, and 300. As shown in FIG. 3, clinical trial-related applications can be categorized into “shared server interacting applications” and “linked server interacting applications.” Shared server interacting applications have a “shared server user interface” 340 that is connected (via a data connection 118) with the shared server 110. Linked server interacting applications have a “linked server user interface” 310 that is connected (via a data connection 280) with a linked server 210 that, in turn, is connected (via at least one data connection 180) with the shared server 110. It should be noted that the shown user interfaces 310, 340 are meant to designate the type of user interface (e.g. shared or linked), and are not meant to show a single user interface for multiple clinical trial-related applications. Shared server interacting applications include, for example, clinical applications (shown in FIGS. 1 and 2 as 120-1, 120-2, and 120-n and in FIG. 3 as 350), enterprise applications 360, and customized applications 370. Examples of clinical applications 120, 350 include, but are not limited to Clinical Trial Management Systems (CTMS), Clinical Data Management System (CDMS), Electronic Data Capture (EDC), Clinical Trial Manager, Clinical Payment Manager, Laboratory Information Management System (LIMS), Interactive Voice Response System (IVRS), Safety Applications, eSubmission Applications, eDiary Applications, Medical Imaging Applications, and other applications designed to be used in clinical trials. Examples of enterprise applications 360 include, but are not limited to Customer Relationship Management (CRM), Enterprise Resource Planning (ERP), Manufacturing Execution Systems (MES), and company financial and accounting systems. Examples of customized applications 370 include, but are not limited to software applications that have been specifically developed to meet the unique needs of a company's clinical trial. Examples of portal applications 320 include, but are not limited to analysis and reports of information derived from the common tables that assist in management of the clinical trial process. Examples of business applications 330 include, but are not limited to Statistical Analysis Systems (SAS), Customer Relationship Management (CRM), Personal Information Management System (PIMS), Enterprise Resource Planning System, Manufacturing Execution Systems, financial and accounting systems, customized applications for clinical trials, and other business applications designed to assist in business solutions.

“Clinical trial data,” as used herein, can be divided into “experimental data” and “operational data.” Experimental data (also called “clinical trial experimental data”) is the clinical trial information or research data that is collected and recorded during a clinical trial that provides the basis of an IND's claim for supporting safety and efficacy of a new product. Operational data (also called “clinical trial operational data,” “clinical trial process data” and “process data”) is information used by the clinical trial-related applications and human subjects to execute the clinical trial process.

As used herein, “semantics” refers to differentiating the meaning of a data term from its format. The format that covers the spelling of language components and the specific rules controlling how the language components are combined is called the language's “syntax.” Syntax, therefore, is one type of semantics. As an example, a semantic error refers to a legal command that does not make sense in the current context. As an example, a syntax error refers to a misspelling in a command.

As used herein, the word “users” refers to a person or persons at organizations or other structures involved in clinical trial processes. Users may include a person or persons involved in the clinical trial process, including, but not limited to those associated with clinical trial organizations.

For understanding the table views and addition, deletion, and/or modification of operational data, “table name” and “table” refer to the name of the table or the table as a whole. As used herein, the “field identifier” and “predefined data field identifier” refer to the column heading titles of the table containing various field identifiers. As used herein, the phrase “data field” refers to any field box under the columns that can be populated with operational data relevant to the field identifiers. Operational data can be added, deleted, and/or modified (referred to herein as “manipulated”) in the data fields in a row or rows under the column headings already generated with field identifiers. As used herein, the phrase “data type” refers to the description as to the type of data populated in the data fields such as a single line of text, number, date, string, and/or other data types.

Exemplary embodiments of the present invention are directed to a system and method for sharing operational data among different clinical trial applications and servers for easy accessibility, reusability, standardization, and integration.

FIG. 1 is a schematic diagram illustrating an embodiment of a shared database system 100 for interacting with clinical trial operational data using a plurality of shared server interacting applications (e.g. clinical application 1, clinical application 2, . . . clinical application N, where N can be any suitable number). The plurality of shared server interacting applications is interchangeably used with the plurality of clinical applications 120-1, 120-2, 120-n. The plurality of clinical applications 120-1, 120-2, 120-n is connected to the shared server 110 by interfacing and communicating through any type of data connection 118. In this shown embodiment, the communication is accomplished using interface technology, including, but not limited to a services-oriented architecture (SOA). By using an SOA, the system's architectural style is built on creating and utilizing business processes by offering services. SOA is a flexible, standardized architecture that is suitable for supporting the connection of various clinical trial software and business applications as well as the sharing of data. Other communication protocols and/or interface technologies could also be used. For example, WS is a technology that can implement SOA (or other interface technologies) by having a standard means of interoperating between software applications that are allowed to run on a variety of platforms and/or frameworks. WS is a system designed to support interoperable machine-to-machine interaction over a network by allowing the various software applications to interface with each other rather than with the users. WS is useful in allowing different applications from different sources to communicate with each other without the requirement of custom-coding and/or agreement on a particular operating system or programming language. Therefore, JAVA can communicate with PERL, and Windows applications can communicate with UNIX applications. There is no requirement to use browsers or HTML, but only to communicate in Extensible Markup Language (XML).

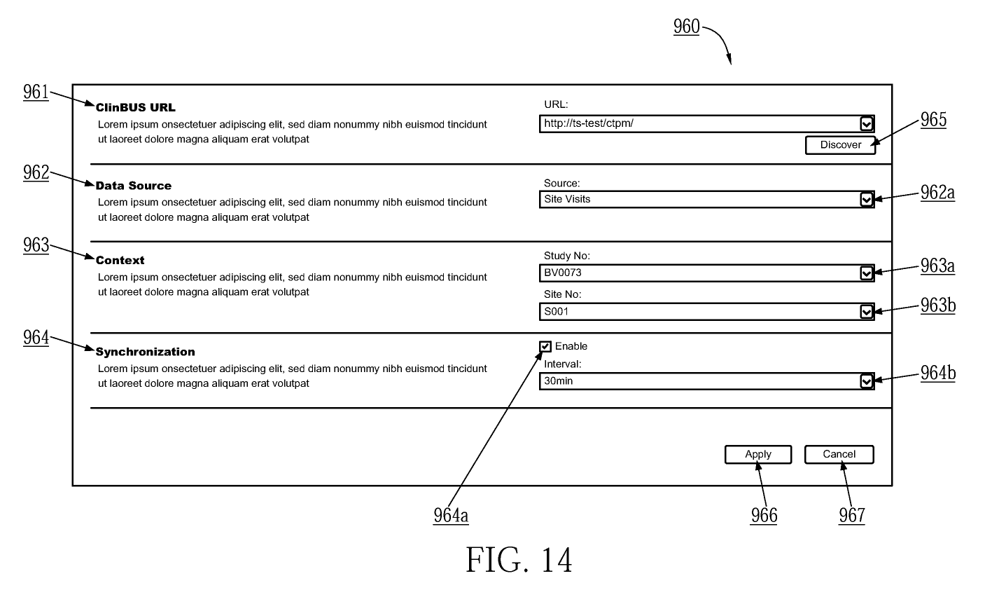

The operational data is stored in the shared server 110 and updated in accordance with requests from the users through any of the clinical applications 120. The shared server 110 may be any type of database server, such as a structured query language (SQL) SERVER that has a centralized database repository (shown in FIGS. 4-6 as shared database 115) for storing and saving operational data in a table format. As will be described in more detail, a shared administrator 150 (the administrator of the shared server 110) or a general administrator 250 (hereinafter referred to jointly as “administrator 150, 250”) can select data source information, provide context information, set synchronization parameters, and select the discovery function by accessing a configuration user interface 960 as shown in FIG. 14. The shared administrator 150 can also input approver information, create access rights for users, and maintain control of addition and deletion of operational data by accessing another configuration interface not shown in the figures. Thereafter, a user can view tables of data and interact using a user interface 310, 340 to input data for the clinical application 120 or linked server 210 to communicate with the shared server 110 as shown in FIG. 3.

FIG. 2 is a schematic diagram illustrating another embodiment of a shared database system 200 for interacting with clinical trial operational data using a plurality of shared server interacting applications (e.g. clinical application 1, clinical application 2) and a plurality of linked server interacting applications via a plurality of linked servers 210 (e.g. linked server 1, linked server 2, . . . linked server N, where N can be any suitable number). The plurality of shared server interacting applications is interchangeably used with the plurality of clinical applications 120-1, 120-2, 120-n. The plurality of linked servers 210-1, 210-2, 210-n is connected to the shared server 110 by interfacing and communicating through any type of interface technology as described herein. The shared database system 200 can be a centralized data repository system that includes a shared server 110 and a shared database 115 (FIGS. 4-6) as a structure for storing operational data. The plurality of linked servers 210-1, 210-2, 210-n is connected to the shared server 110 by interfacing and communicating through interface technology. This figure also shows data connections 118 and data connections 180. Clinical applications 120 may also connect to the shared server 110 as described in relation to FIG. 1.

As described in more detail later, the operational data is stored in the shared server 110 and updated in accordance with requests from any linked server interacting applications through any of the linked servers 210. Linked servers 210 may apply specific server-based software transformations and modifications based upon the defined data to utilize the linked server 210 functionality. The shared server 110 may be any type of database server such as a SQL SERVER for having a database repository with associated software functionality, also referred to as a shared database 115 (shown in FIGS. 4-6) for storing operational data. As described more in detail, the administrator 150, 250 can set configuration parameters for the shared database system 200, select the discovery function to limit the amount of data desired to be synchronized, input approver information, and control access rights from users. Each of the linked servers 210-1, 210-2, 210-n may be any type of server having capabilities of linking with the shared server 110 such as SHAREPOINT Server from Microsoft® or other servers offering a communication protocol to support synchronizion with the shared server 110 for inter-operatively exchanging operational data and updating databases without human intervention.

FIG. 3 is a schematic diagram illustrating another embodiment of a shared database system 300 for interacting with clinical trial operational data using a plurality of shared server interacting applications, such as the clinical applications 350, enterprise applications 360, and customized applications 370 and a plurality of linked server interacting applications, such as the portal applications 320, and business applications 330 through a linked server 210. In this shown embodiment, the shown business applications 330 represent a plurality of business applications 330. In this shown embodiment, the shown portal applications 320 represent a plurality of portal applications 320. The linked server 210 is connected to the shared server 110 by interfacing and communicating through any type of interface technology as previously described. For example, the linked server 210 may be any type of server having capabilities of linking with the shared server 110 such as SHAREPOINT Server from Microsoft® or other servers offering a communication protocol, or other similar services to synchronize with the shared server 110. The linked server interacting applications of the plurality of business applications 330 and the plurality of portal applications 320 interface with the linked server 210 by interfacing and communicating through any type of interface technology. Data connections 118 connect the shared server interacting applications (350, 360, and 370) associated with “shared server user interface” 340 with the shared server 110. Data connection 280 connects the linked server interacting applications (320 and 330) associated with the “linked server user interface” 310 with a linked server 210 that, in turn, is connected with the shared server 110 via at least one data connection 180. Data synchronization techniques using data connections 180 allow interoperability of exchanging any set of operational data from the shared server 110 to any linked server 210-1, 210-2, 210-n or from any linked server 210-1, 210-2, 210-n to the shared server 110 to automatically receive data and update database repositories without requiring human intervention.

The shared database system 100, 200, 300 can integrate all of the different shared server interacting applications and linked server interacting applications such as SAS, CRM, PIMS, CTMS, CDMS, EDC, LIMS, IVRS, Safety Applications, eSubmission Applications, eDiary Applications, Medical Imaging Applications, CRM, ERP, MES, and customized applications for easy accessibility of operational data, reusable field identifiers and operational data in other clinical trials, standardization of clinical trial process with operational data for context and tables, and centralized use of operational data for conducting clinical trials based on semantics as well as syntax for consistency with the advantages of software reuse.

An administrator 150, 250 configures the shared database system 200, 300 by accessing the linked server 210 that launches the configuration user interface 960 (as shown in FIG. 14), allowing the administrator 150, 250 to select and apply configuration parameters. Either administrator 150, 250 can select the linked server 210 to connect to the shared server 110, implement the discovery function for data source information, such as particular tables to be accessed from the shared database 115, providing context information for further limiting the data to be accessed from the shared database 115, and setting synchronization parameters for synchronization when the administrator 150, 250 accesses the configuration user interface 960. A user can then view operational data populated in the tables, and the linked server 210 can communicate with the shared server 110 for requesting, receiving, or updating data. Any user can view and input operational data from the user interface 310 of the portal applications 320, of the business applications 330 through the linked server 210 or of the clinical applications 350, enterprise applications 360, customized applications 370, in order to communicate with the shared server 110 via the data connections 118, 280. Data synchronization via the data connection 180 between the shared server 110 and the linked server 210 allows regular updates and modifications of operational data between the two servers 110, 210.

FIG. 4 is a schematic diagram illustrating another embodiment of the detailed shared database system 100 with its components for interacting with clinical trial operational data using a plurality of shared server interacting applications (e.g. clinical applications 120). The shared server interacting applications are interchangeably used with the clinical applications 120. In this exemplary embodiment, the shared server 110 includes a shared database 115, an access module 117, an option to implement the discovery module 119, and the data source module 122. The shared database 115 is a centralized repository database that stores operational data in a table format. The access module 117 basically functions to send and receive data from any clinical application 120 via the data connection 118 as described herein. Furthermore, the access module 117 updates (using, for example, a communications computer program) any changes to the data stored in the shared database 115 since clinical trials are dynamic and constantly in flux.

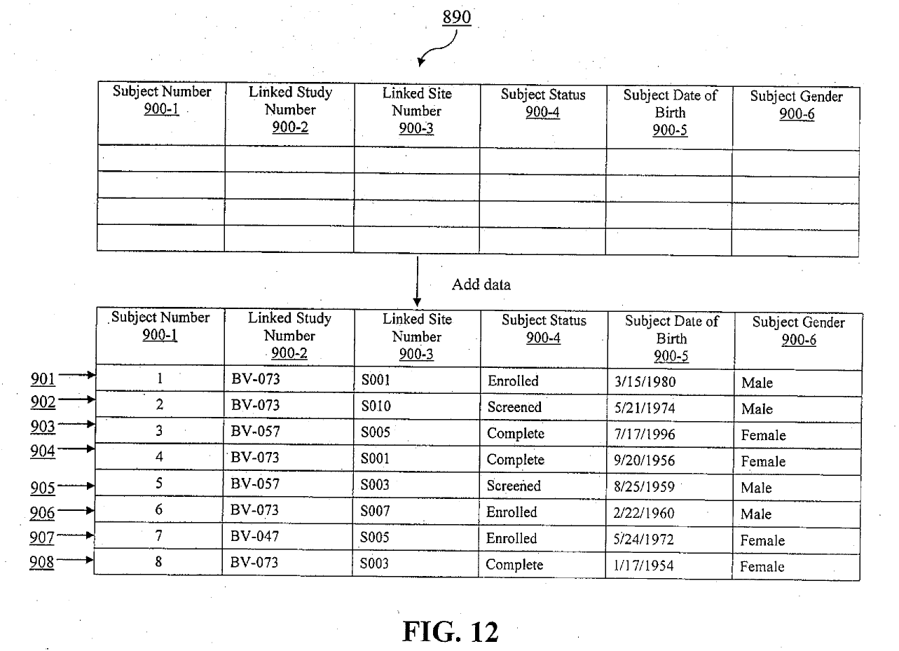

For example, in FIG. 12, the addition of operational data is shown in the table 890 containing field identifiers 900 (shown as 900-1, 900-2, 900-3, 900-4, 900-5, and 900-6) and operational data 901-908 in the data fields in consecutive rows. Exemplary table names or tables 890 include “Subject Records,” “Subject Event Records,” “Site Visit Records,” “Action Item Records,” “Clinical Trial Records,” “Site Records,” “Document Records,” “Site Contact Records,” “Protocol Deviation Records,” “CRF Page Records,” “SAE Records,” “Shipment Records,” “Transaction Records,” “General Contact Records,” “Institution Records,” “Alert Records,” “Correspondence Records,” “Payee Records,” “Invoice Records,” “Payment Item Records,” and other tables that can be stored in the shared system and that are ready to be updated with operational data in the empty data fields. The table names are not limited to the previously described tables, and additional tables can be created to represent a logical organization of operational data that is maintained throughout a clinical trial process using a clinical trial process structure.

In the exemplary embodiment of FIG. 12, the first table 890, as the Subjects Records table, has only the field identifiers 900 (such as “Subject Number” 900-1, “Linked Clinical Trial Number” 900-2, “Linked Site Number” 900-3, “Subject Status” 900-4, “Subject Date of Birth” 900-5, and “Subject Gender” 900-6) already entered in the column headings, while the data fields for operational data are left empty for further input. Each row of data fields is related to a clinical trial, and the addition of operational data occurs as an addition of rows. After operational data is added, the table 890 is populated with operational data under the field identifiers 900. For example, operational data under Subject Number 900-1 is 1, and the data for Linked Clinical Trial Number is BV-073. In row 901, the data show that the subject is enrolled, and the numerical operational data is indicated under the field identifier of Subject Date of Birth 900-5. Any operational data in rows 901 through 908 may be manipulated (e.g. added, deleted, or modified). The code for access module 117 is included in the Code. Therefore, the access module 117 in FIGS. 4-6 detects modified data by addition or deletion of data fields under the column headings or by addition or deletion in any of the rows of data fields.

For creating tables with field identifiers 900, the tables with the column headings use predefined field identifiers for consistency. An exemplary table including the field identifiers 900 in the column heading is shown in FIG. 12. Another exemplary table of “Contact Records” including the predefined field identifiers 900 in the column heading of “Title,” “Linked Clinical Trial Number,” “Linked Site Number,” “Linked Site Name,” “Contact Type,” and “Contact Primary Phone” is also shown in the following with twenty (20) rows of operational data populated beneath and associated with the field identifiers.

TABLE A

| | LINKED | | | | |
|---|---|---|---|---|---|
| | CLINICAL | LINKED | | | CONTACT |
| | TRIAL | SITE | | CONTACT | PRIMARY |
| TITLE | NUMBER | NUMBER | LINKED SITE NAME | TYPE | PHONE |
| Rebecca Dutton, Dr. | SDY-001 | 005 | St. Mary's | Investigator | 555-401-2345 |
| Megan Shephard, Dr. | SDY-001 | 005 | St. Mary's | Investigator | 555-401-2346 |
| James Baker | SDY-001 | 004 | State University | Investigator | 555-401-2347 |
| Cynthia Weston | SDY-001 | 002 | Family Practice | Investigator | 555-401-2348 |
| Becky Landson | SDY-001 | 003 | General Hospital | Investigator | 555-401-2349 |
| Marge Farley | SDY-004 | 001 | General Hospital | Investigator | 555-401-2350 |
| Becky Landson | SDY-004 | 001 | General Hospital | Investigator | 555-401-2351 |
| Bob Parker | SDY-001 | 001 | Arcadia Medical | Sub- | 555-401-2352 |
| | | | | Investigator | |
| Wendy Campos | SDY-001 | 001 | Arcadia Medical | Investigator | 555-401-2353 |
| Lucy Diamond | SDY-005 | 001 | University Medical Center | Investigator | 555-401-2354 |
| Wendy Campos | SDY-005 | 005 | Arcadia Medical | Investigator | 555-401-2355 |
| Roxanne Jefferson, | SDY-005 | 003 | AmClinic | Investigator | 555-401-2356 |
| Mrs. | | | | | |
| Becky Landson | SDY-005 | 004 | General Hospital | Investigator | 555-401-2357 |
| Myron Chan, Mr. | SDY-005 | 001 | University Medical Center | Sub- | 555-401-2358 |
| | | | | Investigator | |
| Jason Forbes, Mr. | SDY-005 | 001 | University Medical Center | Clinical Trial | 555-401-2359 |
| | | | | Coordinator | |
| Lars Talbert, Mr. | SDY-005 | 003 | AmClinic | Sub- | 555-401-2360 |
| | | | | Investigator | |
| Brent Shepherd, Mr. | SDY-005 | 003 | AmClinic | Clinical Trial | 555-401-2361 |
| | | | | Coordinator | |
| Mike Pruett, Mr. | SDY-005 | 002 | McDonnell Research Institute | Sub- | 555-401-2362 |
| | | | | Investigator | |
| Aaron Miao, Mr. | SDY-005 | 002 | McDonnell Research Institute | Clinical Trial | 555-401-2363 |
| | | | | Coordinator | |
| Betty Mason, Mrs. | SDY-005 | 002 | McDonnell Research Institute | Investigator | 555-401-2364 |

Another exemplary table of “Action Item Records” that is stored in the shared database 115 is shown below. The “Action Item Records” table contains predefined field identifiers of “Title,” “Start Date,” “Due Date,” “% Complete,” “Linked Clinical Trial Number,” “Linked Site Number,” and “Action Item Number” with fourteen (14) rows of associated operational data filled in beneath and associated with the field identifiers.

TABLE B

| | | | | LINKED | | |
|---|---|---|---|---|---|---|
| | | | | CLINICAL | LINKED | ACTION |
| | START | DUE | % | TRIAL | SITE | ITEM |
| TITLE | DATE | DATE | COMPLETE | NUMBER | NUMBER | NUMBER |
| Mishandling of Test | May 23, 2008 | May 23, 2008 | 0.00% | SDY-001 | 001 | AIT-00009 |
| Article | | | | | | |
| Investigator must sign and | May 23, 2008 | May 23, 2008 | 0.00% | SDY-001 | 003 | AIT-00010 |
| date protocol | | | | | | |
| File IRB approval of | May 23, 2008 | May 23, 2008 | 0.00% | SDY-001 | 003 | AIT-00011 |
| Protocol | | | | | | |
| Amendment 2 | | | | | | |
| Assess patient abnormal | May 23, 2008 | May 23, 2008 | 0.00% | SDY-001 | 001 | AIT-00012 |
| lab values re clinically | | | | | | |
| significant | | | | | | |
| Revise informed consent | May 23, 2008 | May 23, 2008 | 0.00% | SDY-001 | 001 | AIT-00013 |
| with new risk per protocol | | | | | | |
| amendment | | | | | | |
| File IRB approval of | Jun. 5, 2008 | Jun. 5, 2008 | 0.00% | SDY-005 | 001 | AIT-00003 |
| Protocol Amendment I | | | | | | |
| Assess subject abnormal | Jun. 5, 2008 | Jun. 5, 2008 | 0.00% | SDY-005 | 001 | AIT-00004 |
| lab values re clinically | | | | | | |
| significant | | | | | | |
| Try to contact | May 23, 2008 | May 30, 2008 | 0.00% | SDY-005 | 001 | AIT-00005 |
| sub-investigator to | | | | | | |
| schedule visit | | | | | | |
| Revise informed consent | Jun. 5, 2008 | Jun. 5, 2008 | 0.00% | SDY-005 | 001 | AIT-00006 |
| with new risk per protocol | | | | | | |
| amendment | | | | | | |
| Finish CRF Page | Apr. 2, 2007 | Apr. 2, 2007 | 0.00% | SDY-001 | 003 | AIT-00008 |
| Verification | | | | | | |
| Confirm Shipment | Apr. 2, 2007 | Apr. 2, 2007 | 0.00% | SDY-001 | 002 | AIT-00004 |
| Medical Monitor Review | Apr. 2, 2007 | Apr. 26, 2007 | 0.00% | SDY-001 | 003 | AIT-00007 |
| Resolve Deviation Waiver | Apr. 2, 2007 | Apr. 13, 2007 | 0.00% | SDY-001 | 001 | AIT-00001 |
| Follow up with Dr. | Jun. 6, 2008 | Jun. 6, 2008 | 0.00% | SDY-005 | 001 | AIT-00007 |
| Diamond about meeting | | | | | | |

Another exemplary table of “Subject Event Records” that is stored in the shared database 115 is shown below. The “Subject Event Records” table contains predefined field identifiers of “Title,” “Linked Clinical Trial Number,” “Linked Site Number,” “Event Name,” “Event Status,” “Event Target Date,” and “Event Actual Date” with eleven (11) rows of associated operational data filled in beneath and associated with the field identifiers.

TABLE C

| | Linked | | | | | |
|---|---|---|---|---|---|---|
| | Clinical | Linked | | | Event | Event |
| | Trial | Site | Event | Event | Target | Actual |
| Title | Number | Number | Name | Status | Date | Date |
| Follow-up (002-003): SDY-001- | SDY-001 | 002 | Follow- | Scheduled | Aug. 17, 2007 | Aug. 17, 2007 |
| 002 | | | up | | | |
| Baseline (002-002): SDY-001- | SDY-001 | 002 | Baseline | Scheduled | Jun. 8, 2007 | Jun. 8, 2007 |
| 002 | | | | | | |
| Visit 2 (002-006): SDY-001-002 | SDY-001 | 002 | Visit 2 | Scheduled | Jul. 6, 2007 | Aug. 12, 2007 |
| Visit 2 (002-002): SDY-001-002 | SDY-001 | 002 | Visit 2 | Scheduled | Jun. 22, 2007 | Oct. 22, 2007 |
| Follow-up (002-009): SDY-001- | SDY-001 | 002 | Follow- | Scheduled | Aug. 3, 2007 | Aug. 3, 2007 |
| 002 | | | up | | | |
| Visit 1 (002-009): SDY-001-002 | SDY-001 | 002 | Visit 1 | Scheduled | Jul. 13, 2007 | Jul. 13, 2007 |
| Visit 2 (002-005): SDY-001-002 | SDY-001 | 002 | Visit 2 | Scheduled | Jul. 3, 2007 | Aug. 6, 2007 |
| Off Clinical Trial (002-002): | SDY-001 | 002 | Off | Scheduled | Jul. 6, 2007 | Jul. 6, 2007 |
| SDY-001-002 | | | Clinical | | | |
| | | | Trial | | | |
| Off Clinical Trial (002-003): | SDY-001 | 002 | Off | Scheduled | Jul. 11, 2007 | Jul. 11, 2007 |
| SDY-001-002 | | | Clinical | | | |
| | | | Trial | | | |
| Baseline (002-001): SDY-001- | SDY-001 | 002 | Baseline | Scheduled | Jun. 20, 2007 | Aug. 13, 2007 |
| 002 | | | | | | |
| Visit 2 (002-009): SDY-001-002 | SDY-001 | 002 | Visit 2 | Scheduled | Jul. 20, 2007 | Aug. 30, 2007 |

The discovery module 119 primarily functions to detect and discover any changes in data and configuration settings for synchronizing only a limited number of tables and data based on context information. The discovery module 119 responds to the latest configuration parameters set by at least one of the administrators 150, 250 to either limit access to users and to limit data synchronization for selected tables (also known as data source information) and limited portions of the data within the tables (also known as context information). The discovery module 119 also loads any data source information and context information and transmits such data to the linked discovery module of the linked server 210 or the clinical applications 120. The configuration parameters, including the discovery function and related data source and context information, will be described in more detail and more readily understood in FIG. 14.

The discovery module 119 is optionally available to be used if the administrator 150, 250 decides to implement the discovery function by pressing the Discover button 965 (FIG. 14). Typically, the tables in the shared database 115 have predefined field identifiers in the column headings for creating consistent table structures with consistent field identifiers in that relevant operational data is automatically added, deleted, or modified. Therefore, it is important for the shared administrator 150 to control the field identifiers actually created in the table structures for consistency. One exemplary embodiment of the discovery function is to allow the shared administrator 150 to limit (restrict) users' access to particular predefined field identifiers 900 (FIG. 12) to be added or deleted in the columns by either increasing or decreasing the number of columns with one or more field identifiers to the existing tables in the shared database 115.

As an example, the table 890 with a table name of Subject Records as shown in FIG. 12 illustrates six field identifiers of “Subject Number” 900-1, “Linked Clinical Trial Number” 900-2, “Linked Site Number” 900-3, “Subject Status” 900-4, “Subject Date of Birth” 900-5, and “Subject Gender” 900-6. These tables in FIG. 12 are meant to be exemplary since the shared database system 100, 200, 300 can implement more tables into the shared server 110, providing operational data to be populated in the tables. If another column with a field identifier 900-n (not shown in FIG. 12) needs to be added, such as “Subject Screening Date,” the discovery module 119 automatically updates the table 890 in FIG. 12 by adding an additional column heading with the new field identifier into the table 890 of “Subject Screening Date” and creating a table 890 with six columns. Since the discovery module 119 automatically updates the table 890 or any other table using predefined field identifiers 900 in the columns, any modified tables with additional columns can be transmitted to clinical applications 120 or linked servers 210 as illustrated in FIGS. 4-6. All newly modified tables with additional field identifiers 900 in column headings updated in the shared database 115 are transmitted to the linked discovery module 219 to update the linked server database 215 or other databases in the clinical applications 120.

By implementing the discovery function as selected and configured by the administrator 150, 250, the data source module 122 retrieves relevant tables with changes to only permit users to access a selected number of tables with operational data and to limit synchronization of tables with changes to be transmitted. For example, instead of retrieving all of the following tables “Subject Records,” “Subject Event Records,” “Action Item Records,” “Site Visit Records,” “Action Item Records,” “Clinical Trial Records,” “Site Records,” “Document Records,” “Site Contact Records,” “Protocol Deviation Records,” “CRF Page Records,” or “SAE Records,” the data source module 122 retrieves only the “Subject Records” table because the “Subject Records” table has table structure changes. After the shared administrator 150 implements the discovery function, data source information 962 as illustrated in FIG. 14 appears with multiple selections to choose a table or limited choice of tables to be accessed by users. Further, the administrator 150, 250 can also configure the context information 963 that further limits users to access selected portions of the tables, such as by limiting users to data pertaining only to certain studies or sites. The data source information and context information functions may be more readily understood in relation to FIG. 14.

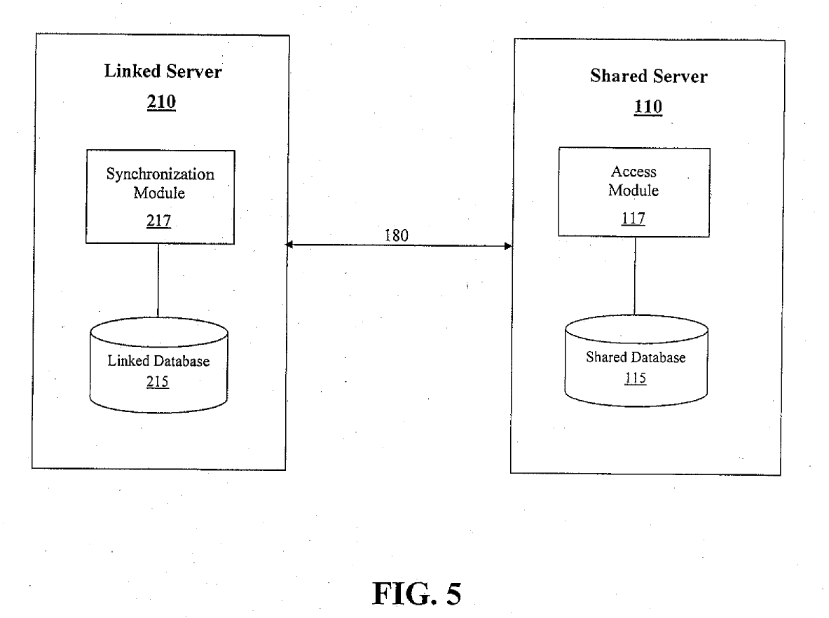

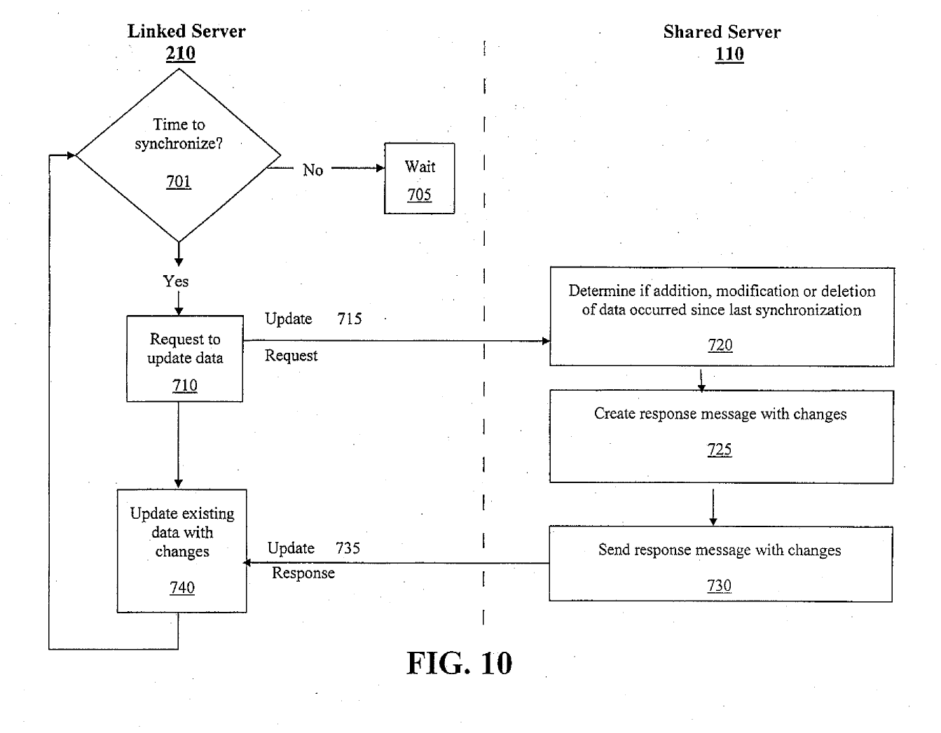

FIG. 5 is a schematic diagram illustrating another embodiment of the detailed shared database system 200 with its components for interacting with clinical trial operational data and synchronizing with a linked server 210. The synchronization module 217 executes data synchronization with the shared server 110. In FIG. 14, the administrator 150, 250 can select on the configuration user interface 960 to set the synchronization time interval by selecting from 10 seconds, 30 seconds, 1 minute, 5 minutes, 10 minutes, 30 minutes, hourly, or daily for the linked server 210 to synchronize with the shared server 110. The synchronization interval allows the frequency of synchronizing with the shared server 110 for exchanging and updating data. The synchronization module 217 also receives data with changes, and the linked server database 215 is updated, saving the newly modified data. The steps of synchronizing the linked server 210 with the shared server 110 are addressed in FIG. 10.

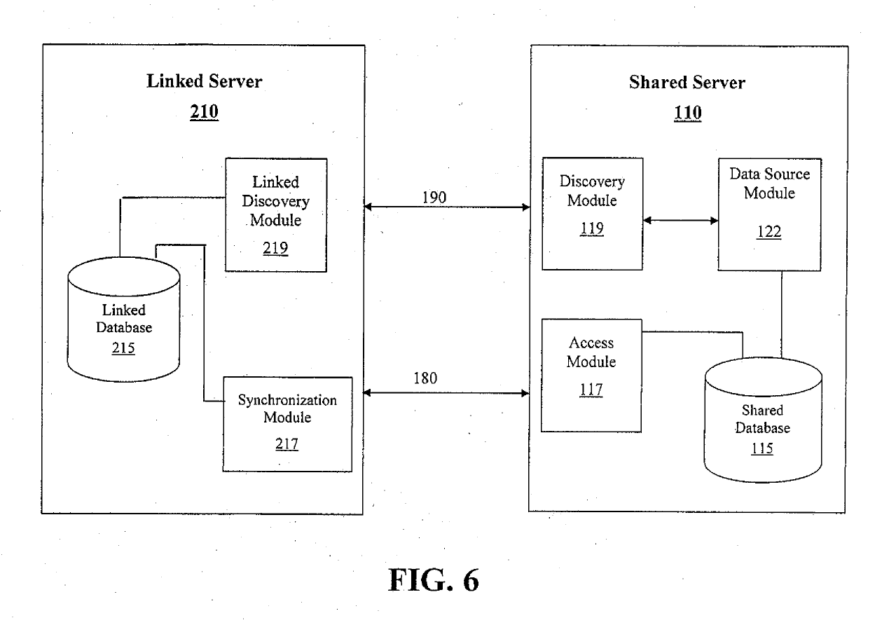

FIG. 6 is a schematic diagram illustrating another embodiment of the detailed shared database system 200 for interacting with clinical trial operational data with its components, including a discovery module 119 and synchronizing with a linked server 210. The discovery module 119 and the linked discovery module 219 communicate by any data connection (shown a data connection sub-channel 190). The linked server 210 and the shared server 110 transmit operational data by interfacing and communicating through any type of data connection 180.

After an administrator 150, 250 sets the configuration parameters, the linked discovery module 219 queries the discovery module 119 for the list of available data source information or tables and returns the list to the linked discovery module 219. The configuration parameters are stored in the linked discovery module 219. During data synchronization as initiated from the synchronization module 217, the linked discovery module 219 reads the configuration settings for data source information to query the data source information for any changes in data for the specific tables or data sources. For example, when the data source module 122 retrieves and reviews the queried tables in the shared database 115 for any changes in data, only data with changes are retrieved and sent to the linked server 210 to be updated in the linked server database 215. Even though the shared server 110 in FIGS. 4-6 is shown to be implemented as a single object, it should be appreciated that the shared server 110 and the shared database 115 can be implemented as one or more distributed storage devices and/or computer systems with each being communicatively linked with one another.

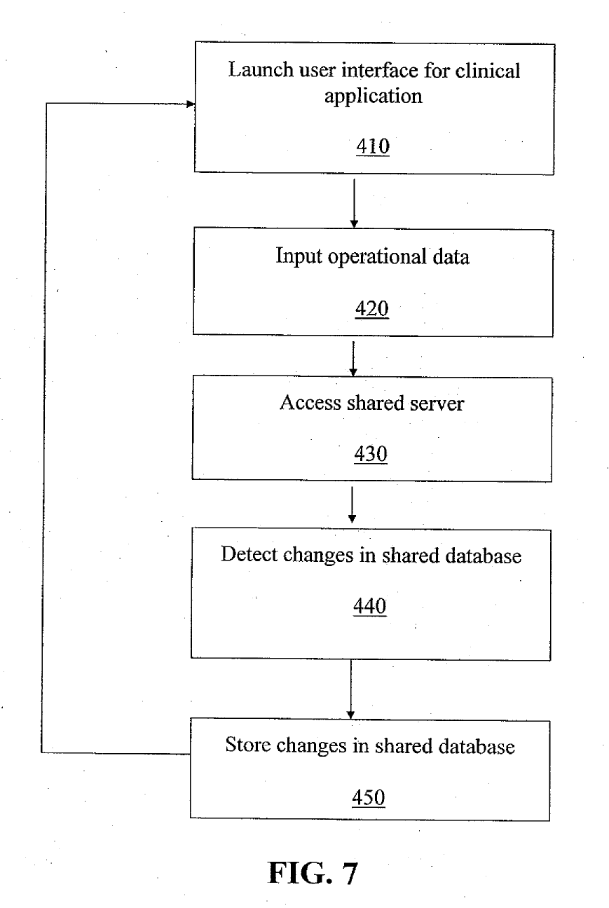

FIGS. 7-11 are flow charts illustrating methods and systems for sharing operational data with linked server interacting applications via linked servers and shared server interacting applications. It will be understood that each block and combination of blocks in these flow charts may be implemented by computer program instructions (executable instructions). These computer program instructions may be loaded onto a computer (or the memory of the computer) to produce a machine, such that the instructions that are executed on the computer create structures for implementing the functions specified in the flow chart block or blocks. These computer program instructions may also be stored in a memory that can direct a computer to function in a particular manner, such that the instructions stored in the memory produce an article of manufacture including instruction structures that implement the function specified in the flow chart block or blocks. The computer program instructions may also be loaded onto a computer to cause a series of operational steps to be performed on or by the computer to produce a computer-implemented process such that the instructions that execute on the computer provide steps for implementing the functions specified in the flow chart block or blocks. Accordingly, blocks of the flow charts support combinations of structures and combinations of steps for performing the specified functions. It will also be understood that each block and combination of blocks in the flow charts may be divided and/or joined with other blocks of the flow charts without affecting the scope of the invention.

FIG. 7 is a flow chart illustrating another exemplary embodiment of a method of updating data through a clinical application 120. The shared server interacting application is interchangeably used with the clinical application 120, 350. In step 410, a user interface 340 is launched for a user to interact with the user interface 340 in providing operational data. The clinical application 120 in turn communicates with the shared server 110. In step 420, a user can input operational data collected during a clinical trial process by interacting with the user interface 340. The user interface 340 can be any type of customized user interface 340 that is specifically tailored to each clinical application 350, enterprise application 360, and/or customized application 370. The shared server 110 is not responsible for customizing the user interface 340. If a particular clinical application 120 is formatted to allow a user to view the data in the shared database 115, the user interface 340 can be configured to allow users to view the data in tables. Typically, a user may not access the tables directly from the shared database 115, and the clinical application 120 accesses the shared server 110 via a data connection 118 without any human intervention. Once the shared server 110 is accessed, the access module 117 automatically updates the data into a table or tables by adding, deleting, or modifying data in the data fields of tables. In FIG. 12, an exemplary table view illustrates the empty data field boxes, adding operational data under the field identifiers 900 in the column headings of the table by populating the data fields with relevant data types.

In step 430 of FIG. 7, the shared server 110 is accessed by the clinical application 120, 350 when a user interacts with the user interface 340 to input, delete, or modify operational data. The step of 430 allows the clinical application 120, 350 to contact the shared server 430 with messages of updated data or with changes. In step 440, the access module 117 receives the message and detects changes in the shared database. In step 450, the changes are updated and stored in the shared database 115 with the new information as received from the clinical application 120 to add, modify, or delete the data in the tables stored in the shared database 115. This sequence of steps continues to repeat between the clinical application 120, 350 and the shared server 110 in updating operational data continuously.

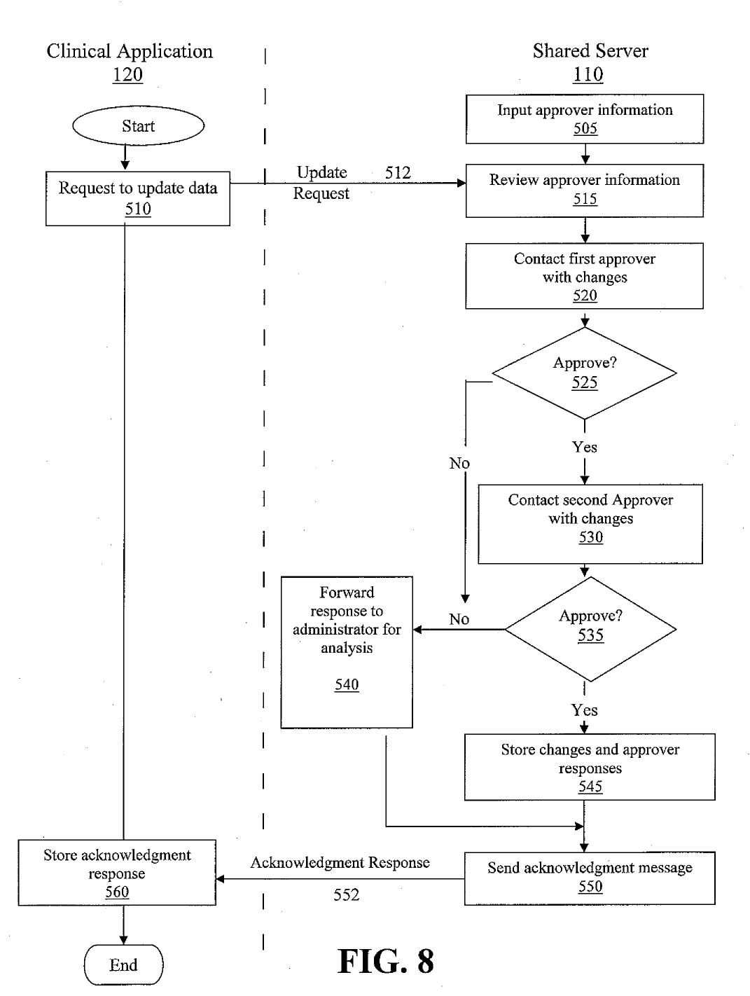

FIG. 8 is a flow chart illustrating a method of approving changes with approvers before updating the data with changes in another exemplary embodiment. An approver module is not shown in any figures; however, the shared system has a capability of implementing the approver module. In step 505, the approver function allows an administrator 150, 250 to input approver information such as the name of a regulatory agency or the institutional review board to be saved in the shared database 115 or another database linked to the shared server 110. The approver information can be similarly input by using an approver user interface to allow the shared system to contact approvers upon request from the clinical application 120, 350 to update data. In step 510, the clinical application 120, 350 requests to update operational data and transmits an update request to the shared server 110, as illustrated in step 512. Upon receiving the update request from the clinical application 120, 350, the shared server 110 reviews approver information saved in the shared database 115 or in other databases linked with the shared server 110 as shown in step 515. In step 520, the shared server 110 automatically contacts a first approver with the updated data or changes via any communication means such as e-mail communication or other means of communicating.

With continuing reference to FIG. 8, at 525, the approver module of the shared server 110 waits until it receives a “yes” or a “no” response from the first approver. If the first approver's response is a “yes,” the shared server 110 proceeds to contact a second approver with the updated data as shown in step 530. Similarly, at 535, the shared server 110 waits to receive a response from the second approver. If the response is a “yes,” the updated data or changes are stored in the shared database 115 as shown at 545. If the response from either the first approver or the second approver is a “no,” the response is forwarded to the shared administrator 150 for further analysis and monitoring at 540. Once all the requests of updated data are cleared and/or approved by the relevant approvers, the shared server 110 stores the changes and responses from approvers in the shared database 115. At 550, the shared server 110 sends an acknowledgment message with the changes and transmits the acknowledgment message response 552 to the clinical application 120, 350. At 560, the clinical application 120, 350 acknowledges the response by storing the acknowledgment response 560 in its database.

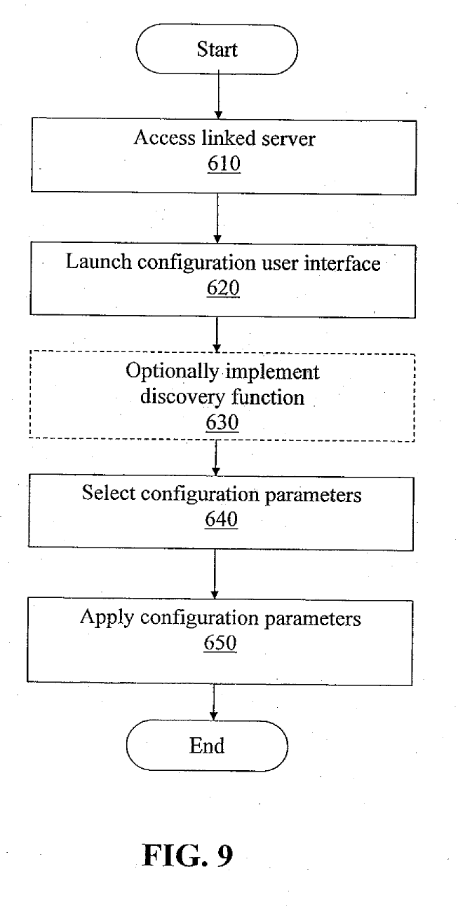

FIG. 9 is a flow chart illustrating a method of configuring the shared database system 100, 200, 300 and optionally selecting a discovery function carried out by a general administrator 250 from the linked server 210 or by a shared administrator 150 from the shared server 110. The administrator 250 and the shared administrator 150 may be the same administrator or two separate administrators. In this example, in step 610, the general administrator 250 accesses the linked server 210 by logging into the linked server 210. In step 620, upon logging into the linked server 210, the linked server 210 automatically launches a configuration user interface with which the administrator 250 can interact in order to set configuration parameters. In step 630, the administrator 250 is given an option to select the discovery function in order to implement the discovery function. By pressing the Discover button 965, as shown in FIG. 14, the discovery function is implemented. At step 640, the administrator 250 further selects other configuration parameters from the configuration user interface 960 that is shown in FIG. 14. Other configuration parameters include selecting the data source information as presented in one or more tables, selecting the context information such as site number or clinical trial number as presented in one or more selections, enabling synchronization, and deciding on synchronization interval. The configuration parameters are set when the administrator 150, 250 presses the apply button 966 as shown in step 650 (applying the configuration parameters). The configuration of the shared database system 100, 200, 300 is saved in the discovery module 119 for connecting to the shared server 110, working with certain tables selected in the data source information portion, providing context information such as limiting viewable access to specific clinical trial numbers and site numbers, and synchronizing based on the time interval configured by the administrator 150, 250. It should be noted that it is optional for the administrator 150, 250 to implement the discovery function that allows users, for review and synchronization, to discover newly modified data in a limited number of tables and/or newly modified data limited to specific studies and sites. When applying the configuration parameters, the linked discovery module 219 queries the discovery module 119 for the list of available data source information or tables and returns the list to the linked discovery module 219. The linked discovery module 219 stores the configuration parameters.

FIG. 10 is a flow chart illustrating a method of updating data between a linked server 210 and a shared server 110 in another exemplary embodiment. At 701, the linked server 210 operates according to the synchronization interval configured by one of the administrators 150, 250 (in a manner similar to steps 640 and 650 of FIG. 9). Depending on the synchronization time interval, at 705 the linked server 210 waits until it is time to synchronize. At 710, the linked server 210 (more particularly, the synchronization module 217 (FIG. 5 and FIG. 6)) is requesting to update data, and the message for the update request is transmitted to the shared server 110 at 715. After receiving the message for requesting data, the access module 117 of the shared server 110 determines whether any addition, modification, or deletion of data has occurred since the last data synchronization with the linked server 210, as illustrated in step 720. Each row of data includes time stamp information so the access module 117 can determine if changes were made to the table.

At 725 of FIG. 10, the access module 117 (FIGS. 4-6) of the shared server 110 creates a response message containing any new information or changes in data, including the time stamp information since the last synchronization. In step 730, the access module 117 sends a response message containing only the rows of new data or modified data. At 735, the changes of data from the table structure are transmitted as an update response to the linked server 210. Once the synchronization module 217 receives the update response with the changes, the synchronization module 217 updates the existing data in the linked server database 215 as shown in step 740. Based on the synchronization time interval already configured by the linked server 210, the sequence of steps continuously repeats in detecting changes in the shared database 115, consequently updating data in the respective linked server database 215 (FIG. 5 and FIG. 6).

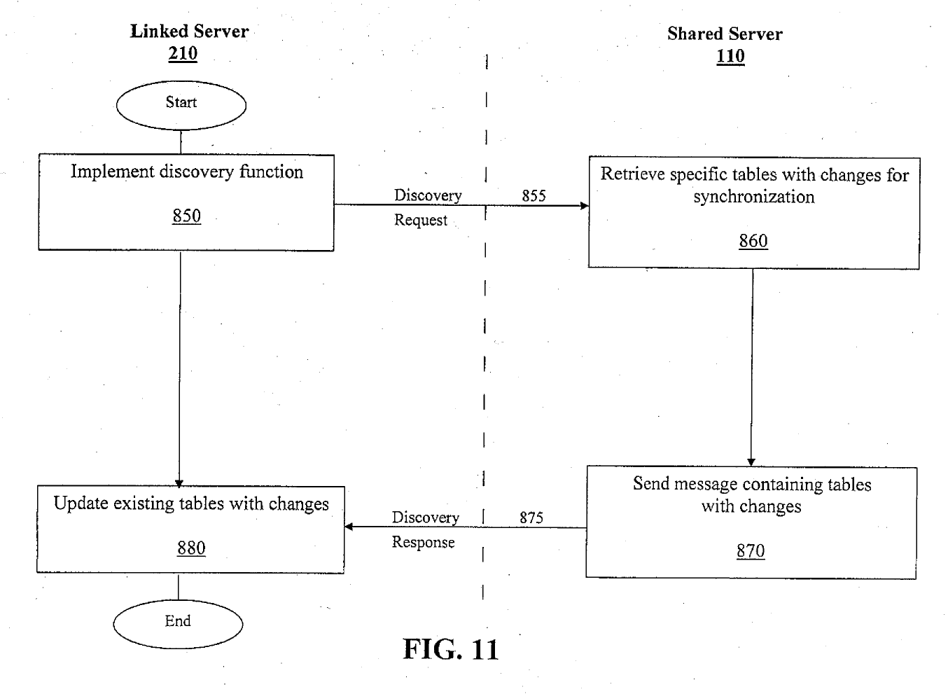

FIG. 11 is a flow chart illustrating a method of implementing the discovery function in another exemplary embodiment. At 850, the administrator 150, 250 has selected the discovery button 965 (FIG. 14) to implement the discovery function that has been configured to execute the linked discovery module 219 to communicate with the discovery module 119 and the data source module 122 (FIG. 4 and FIG. 6) of the shared server 110. By implementing the discovery function, the linked server 210 sends a discovery request 855 to the shared server 110 via a data connection, as previously described. During data synchronization 860, as initiated from the synchronization module 217, the linked discovery module 219 reads the configuration settings for data source information to query the data source module 122 for any changes in data for the specific tables or data sources. For example, when the data source module 122 retrieves and reviews the queried tables in the shared database 115 for any changes in data, only data with changes are retrieved and sent to the linked server 210 to be updated in the linked server database 215. When the discovery module 119 receives the discovery request, the data source module 122 retrieves only tables with changes for synchronization from the shared database 115. Further, the data source module 122 retrieves only the tables including specific data matching the context information. For examples, the tables only contain rows of data matching selected clinical trial numbers or sites previously configured by the administrator 150, 250, instead of retrieving all the data as contained within the tables. At 870, the discovery module 119 sends a message containing specific tables with changes to the linked discovery module 219 of the linked server 210. At 880, upon receiving the changes, the synchronization module 219 updates the existing tables in the linked server database 215 once data with changes are synchronized between the two servers 110, 210.

FIG. 12 is an exemplary table view illustrating updating data in tables. The table 890 of this exemplary embodiment is the “Subject Records” table. As previously described, there are multiple tables in the shared database 115 with predefined field identifiers in the column heading portions that are ready to be populated with operational data. In this exemplary embodiment, there are six field identifiers 900 in the column headings, even though the “Subject Records” table may have more than six predefined field identifiers. The access module 117 automatically generates these tables with predefined field identifiers 900 in the column headings and updates the rows of data below the field identifiers 900. Only six field identifiers 900 are illustrated as an example. The first field identifier is “Subject Number” 900-1. The second field identifier is “Linked Clinical Trial Number” 900-2. The third field identifier is “Linked Site Number” 900-3. The fourth field identifier is “Subject Status” 900-4. The fifth field identifier is “Subject Date of Birth” 900-5, and the sixth field identifier is “Subject Gender” 900-6. The data fields below the field identifiers 900 are empty and available to be populated with operational data. After adding operational data, rows 901 through 908 are shown to be added. This is an example of the access module 117 taking new operational data and automatically populating relevant data types under the field identifiers 900. Typically, operational data is added, deleted, or modified as a row of information. Therefore, the first row 901 is an addition of a data set associated with the field identifiers 900. Any data within a row can be modified and also updated by the access module 117. Further, any row 901 or rows 901-908 of operational data can be deleted from the table 890.

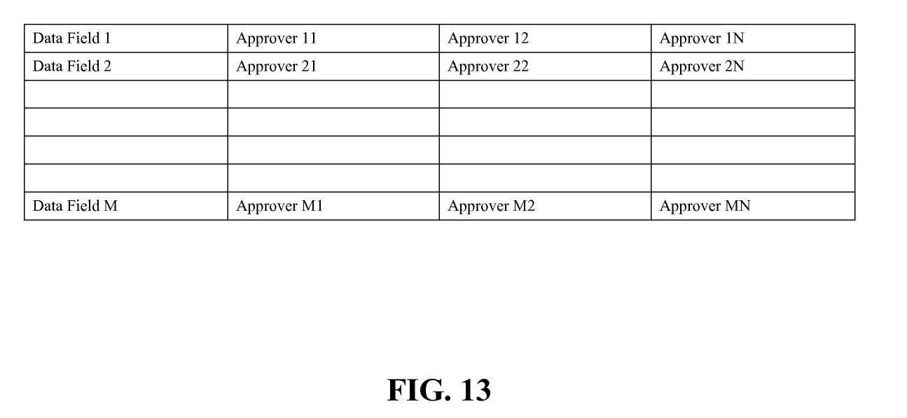

FIG. 13 is an exemplary table view illustrating a plurality of data in data fields and a plurality of approvers. Based on the approver responses and related data that have been approved as described in FIG. 8, an administrator 150, 250 can generate a table associating specific data in the data fields with a specific approver for simple viewing and integrating approver information for each data. The data fields are shown in the left-hand column and the different approvers are input in a row format. For example, the first “Data Field 1” can refer to patient enrollment status and “Approver 11” can refer to the e-mail address of the first approver. The number of approvers can vary for each row. Generating table views of this type of association between data and approvers allows users to view a clinical trial process in terms of data already approved and data needing further approval. Previously, all the approver information was compartmentalized in different locations and databases, making it almost impossible to know whether certain operational data had been approved or not without contacting every location and accessing various databases and application. This integration of approver information with operational data is extremely valuable for users.

FIG. 14 is a screen shot illustrating a configuration user interface 960 for an administrator 150, 250 to set configuration parameters in another exemplary embodiment. When an administrator 150, 250 logs into the linked server 210, this configuration user interface 960 launches for the administrator 150, 250 to set configuration parameters. The connection portion 961 allows the administrator 150, 250 to select the URL of the shared server 110 from the linked server 210 to connect with the shared server 110. The Discover button 965 is optionally available to be selected by the administrator 150, 250. By pressing the Discover button 965, the data source information 962 and context information 963 appear for further selections to be made. In 962a, the data source information 962 can include any of the table names such as “Subject Records,” “Subject Event Records,” “Site Visit Records,” “Action Item Records,” “Clinical Trial Records,” “Site Records,” “Document Records,” “Site Contact Records,” “Protocol Deviation Records,” “CRF Page Records,” “SAE Records,” “Shipment Records,” “Transaction Records,” “General Contact Records,” “Institution Records,” “Alert Records,” “Correspondence Records,” “Payee Records,” “Invoice Records,” “Payment Item Records,” and other tables stored into the shared database to be selected by the administrator 150, 250. If the administrator 150, 250 selects only “Subject Records,” and “Document Records,” only these tables will be retrieved by the data source module 122 from the shared database 115. By retrieving only these tables, the amount of data to be synchronized between the clinical applications 120 and the shared server 110, or between the linked server 210 and the shared server 110, is minimized and access to users from the user interfaces 310, 340 are also limited.

With reference to FIG. 14, the context information 963 refers to the type of field identifiers 900, such as the “Clinical Trial Number” or “Site Number.” Therefore, only rows of data that match with the “Clinical Trial Number” or “Site Number” are retrieved by the discovery module 119 from the shared database 115 rather than retrieving the entire table populated with all the data. Any changes within specific tables and data matching with the selected context information are retrieved to minimize the amount of data to be synchronized between the two servers 110, 210 and updated in the databases 115, 215. The synchronization information 964 includes enabling synchronization between the shared server 110 and the linked server 210 when the administrator 150, 250 checks the enable check box 964a. The administrator 150, 250 can also select the time interval with the options of 10 seconds, 30 seconds, 1 minute, 5 minutes, 10 minutes, 30 minutes, hourly, or daily for the linked server 210 to synchronize with the shared server 110. The synchronization time interval sets the frequency of synchronizing with the shared server 110 for exchanging data. After the selections are made by the administrator 150, 250, the administrator 150, 250 sets the configuration parameters by pressing the apply button 966. The administrator 150, 250 can cancel any of the configuration parameters by pressing the cancel button 967. The linked server 210 and the shared server 110 automatically operate in accordance with the configuration parameters set by the administrator 250 until the configuration parameters are modified. By utilizing the discovery function, the administrator 150, 250 is able to control the tables and data accessed by the users and is also able to alleviate unnecessary synchronization of data.

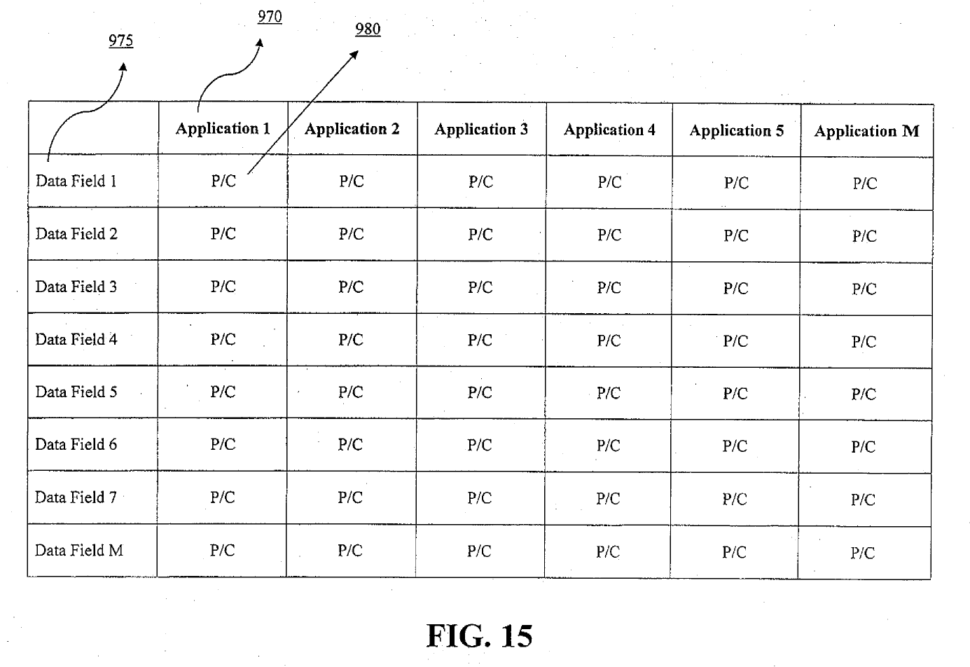

FIG. 15 is an exemplary permissions table illustrating a plurality of shared server applications and linked server applications 970 such as clinical applications, enterprising applications, customized applications, or other clinical trial-related applications with a plurality of data fields 975 configured as either a producer or a consumer. The permissions table defines access rights in terms of whether a particular application 970 can read and write the data as a “Producer” or only read the data as a “Consumer.” The access module 117 reviews the data and associates the operational data 975 with various applications 970 from the shared database 115 by setting permissions for a specific application 970 as the producer or consumer of operational data. This exemplary table in FIG. 15 is configured as a “Producer” or “Consumer” (P/C 980) of data based on a clinical trial basis. Even though the data is residing in various applications, the permissions configuration determines which application will be producing the data and consuming the data. This permissions configuration does not alter any data, however, and only configures the permission level between producing and consuming data.

For example, a clinical trial was conducted without using an EDC application, and the status information as a piece of data has been input using a CTMS application Similarly, in another clinical trial, both the EDC application and CTMS application are used for collecting operational data. In this instance, instead of going through the CTMS and to the EDC to obtain the status information, the EDC application can be designated as the producer rather than the CTMS. Another example includes contact information as a piece of data that may originate from a Contract Research Organization (CRO) Customer Relationship Management (CRM) system that may be utilized by other clinical applications, such as the EDC. Another example includes a clinical trial whereby a CRM is not involved at all, and the sponsor's CTMS system may be the only originator or source of the operational data. Another example may include operational data such as lot shipping information that is provided by a Manufacturing Execution System (MES) if involved in a clinical trial, or directly input via a CTMS.

Therefore, instead of establishing a point-to-point contact or communication in order to obtain the contact information or another piece of data through other applications to the originator of data that is time-consuming, inefficient, and unproductive, the shared system 100, 200, 300 can generate an integrated table to allow any user to view the permissions table to obtain the necessary information. Operational data can be updated in the databases without affecting the permissions table; and after the permissions table is generated, the permissions table can be reused and carried over to other trial application software configurations. The wide variety of known clinical trial-related applications overlaps operational data that are managed by each clinical trial-related application and require reporting and analysis of operational data to be customized on a per-trial basis. The system and method described herein still supports a wide variety of clinical trial-related applications, but it retains the key operational data in a common format in terms of syntax and semantics (common data definitions) while allowing the development of software components and related trial-management methods to be reused in multiple clinical trials.

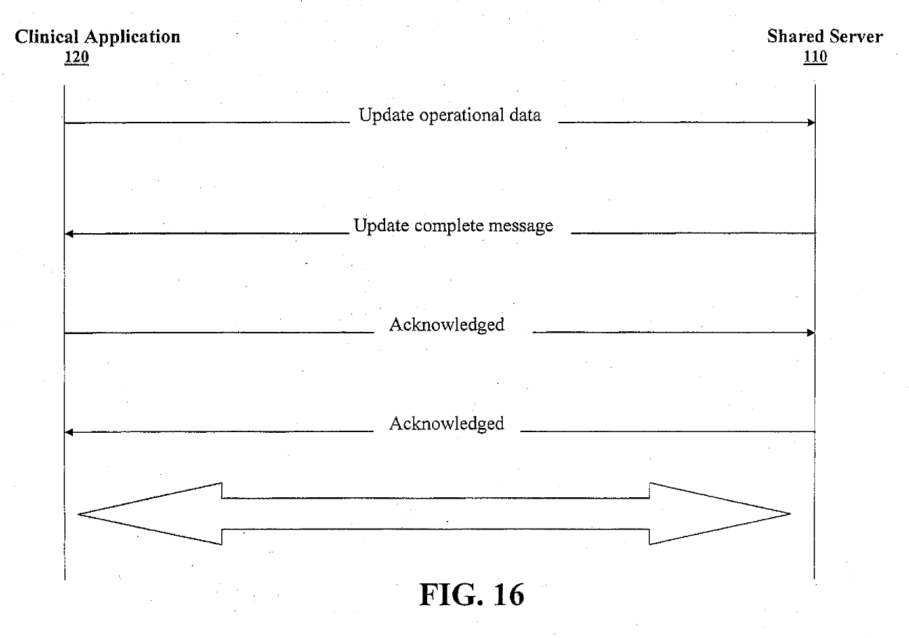

FIG. 16 is an exemplary embodiment of a message flow between a clinical application 120 and a shared server 110. The clinical application 120 is used interchangeably with a shared server interacting application. When a user inputs new data to a clinical application 120 through a user interface 340 (FIG. 3), the clinical application 120 sends a message to update operational data to the shared server 110. Upon receiving the message to update data, the shared server 110 updates the table with changes and stores the changes in the shared database 115. The shared server 110 sends a message back to the clinical application 120, notifying the clinical application 120 that the update is completed. Both of these messages are acknowledged by the clinical application 120 and the shared server 110, consecutively creating audit trail information. This audit trail information can be used to create reports from the shared system for records and submission. The shared system can provide a centralized clinical trial operational data hub for recording of transaction acknowledgment and sequence verification. It should be noted that this optional acknowledgment method provides an additional level of robustness for the interchange of operational data, but is not required. A single message for each transaction to update the shared server 110 will also provide a satisfactory implementation of the present invention.

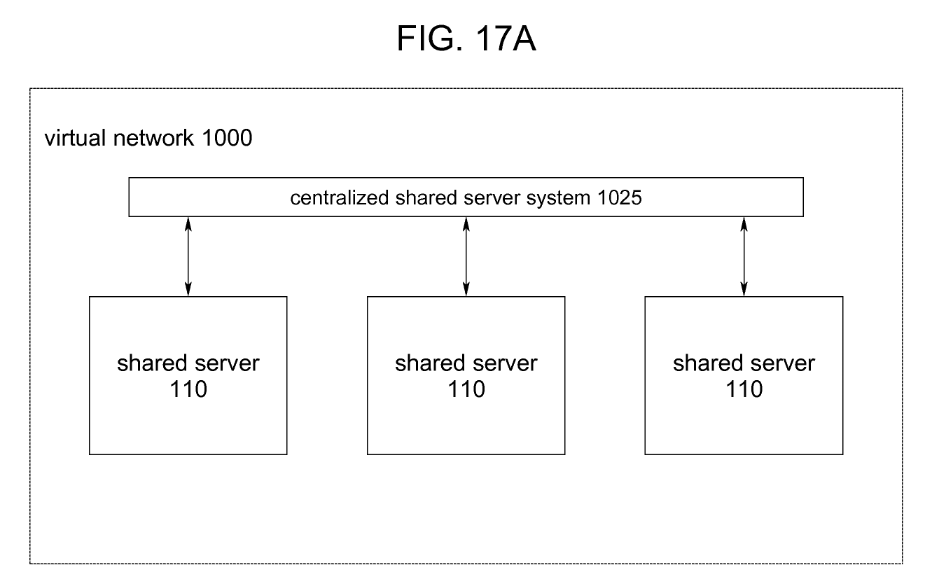

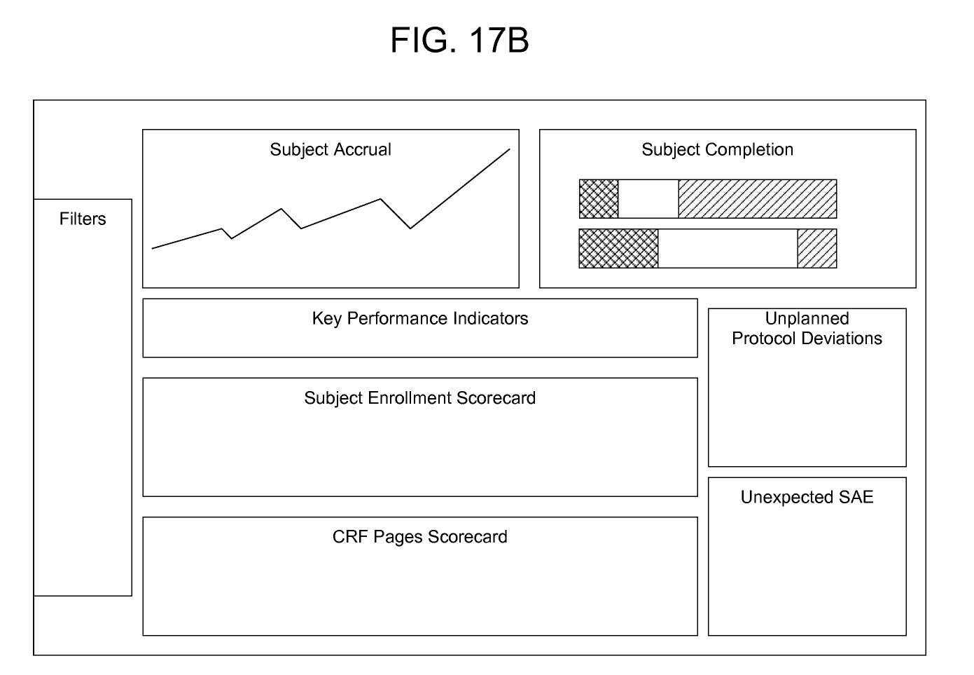

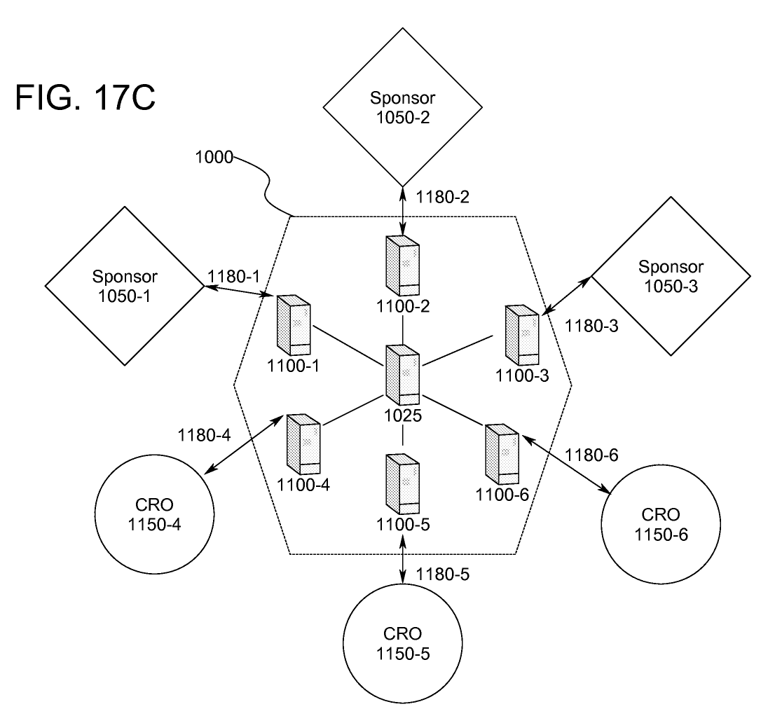

FIGS. 17A, 17B, 17C, 18A, 18B, 19, and 20 show a simplified system for interconnecting clinical trial organizations in a network using a virtual network 1000.

As shown in FIG. 17A, central to this interconnecting concept is the fact that a “Virtual Study Management Network (VSMN)” (shown as virtual network 1000) interconnects a centralized shared server system 1025 with a network of shared database systems 100 (FIG. 1), 200 (FIG. 2), database shared servers 110, and/or shared databases 115. The virtual network 1000 is realized by connecting a centralized shared server system 1025 with shared server(s) 110. The centralized shared server system 1025 (and/or the complete virtual network 1000) could reside in at least one independent (stand-alone) server connected to shared server(s) 110 or could reside physically in at least one of the shared servers 110. The functionality of the centralized shared server system 1025 and the complete virtual network 1000 sit above the shared servers 110 and manage access rights and data synchronization between the shared servers 110 for the subset of data within those rights. This is more than just a physical interconnection. For example, permissions and synchronization are performed by the centralized shared server system 1025 so that a network of distributed shared servers 110 acts as a centralized virtual network 1000. Further, using the virtual network 1000, clinical trial organizations (e.g. sponsors and CROs) can perform “functional outsourcing” or “selective outsourcing.” In other words, the clinical trial organizations can allocate specific responsibilities for managing a specific function within the clinical trial. For example, a sponsor may retain responsibility for site payments, but may outsource the site monitoring function to a CRO. (Put another way, the virtual network 1000 allows the exchange of operational data between a centralized shared server system and a plurality of shared servers as a means for delegating responsibility to other clinical trial organization users for producing subsets of operational data with limited data access rights.) The problem today is that it is very difficult to obtain a common view of the information because the data resides within the CRO's software system. The common format and semantics of the shared servers 110 facilitate the implementation of the virtual network 1000. Using the system and method described herein, a “common data view” is provided that shows information in a readily accessible format (e.g. charts) from the perspective (or viewpoint) of the appropriate clinical trial organizations. As shown in FIG. 17B, information shown in an exemplary common data view might include, subject accrual (based on “Subject Records” and possibly other tables), subject completion (based on “Subject Event Records” and possibly other tables), unplanned protocol deviations (based on “Protocol Deviation Records” and possibly other tables), unexpected SAE (based on “SAE Records” and possibly other tables), and key performance indicators such as a subject enrollment scorecard (based on “Subject Records” and possibly other tables) and CRF pages scorecard (based on “CRF Page Records” and possibly other tables).

FIG. 17C is an alternative view of the virtual network 1000 using a centralized shared server system 1025 to interconnect a plurality of shared servers 110 (shown as 1100-1, 1100-2, 1100-3, 1100-4, 1100-5, and 1100-6, but referred to generally as 1100) to create a centralized database that can be used to provide a common view of the operational data (“common data view”). The centralized shared server system 1025 is a server used to interconnect shared data stored within shared databases 115 (as shown in FIGS. 4-6) of the shared servers 1100 to facilitate clinical data synchronization and data access rights. This allows clinical trial organizations (shown as sponsors 1050-1, 1050-2, and 1050-3 and CROs 1150-4, 1150-5, and 1150-6) to establish virtual networks 1000 of interconnected clinical applications 350 (FIG. 3), enterprise applications 360 (FIG. 3), and customized applications 370 (FIG. 3) for clinical trial studies. The centralized shared server system 1025 synchronizes any shared clinical trial information across the interconnected shared servers 1100 using a synchronizing computer application. Furthermore, the centralized shared server system 1025 allows management of the virtual network 1000 of the shared servers Implementation of the shared servers 1100 via the centralized shared server system 1025 is dependent upon the shared servers' 1100 capability of providing a common operational data environment for different clinical trial studies. The centralized shared server system 1025 also manages the set-up and configuration of each virtual network created by the data connections 1180-1, 1180-2, 1180-3, 1180-4, 1180-5, and 1180-6 as well as the synchronization rules by allowing each clinical trial organization to configure its respective server 1100 via a user interface. Implementation does not require operational data to be stored within the centralized shared server system 1025 as in the shared database 115 within the shared servers 110, 1100.

The centralized shared server system 1025 may be or may include a separate computer application (a synchronizing computer application) that synchronizes data among various clinical trial organizations that are seeking to collaborate on the management of a particular clinical trial. The synchronization data connections 1180-1, 1180-2, 1180-3, 1180-4, 1180-5, and 1180-6 (referred to generally as 1180) allow interoperability of exchanging any set of operational data from the centralized shared server system 1025 to and from any shared server 110, 1100 to automatically receive data and update database repositories within the shared servers 110, 1100 without requiring human intervention. The automatic synchronizing of the clinical trial operational data may be based on common data definitions based on the data access rights associated with the clinical trial operational data within the plurality of shared servers.

The centralized shared server system 1025 also provides a user interface for each of the clinical trial organizations to access and configure data access rights in terms of a “Producer” or a “Consumer,” as previously described in FIGS. 13-16 for the operational data retained within the shared databases 115. The centralized shared server system 1025 further provides a user interface to allow users to set a synchronization interval between synchronization of the operational data between the shared servers 110, 1100. The configuration setting may be changed by any one of the clinical trial organizations to read (viewing access) and write (changing access) the data as a “Producer” or only to read (viewing access) the data as a “Consumer” based on the permissions or data access rights set herein from the centralized shared server system 1025, and is not limited to only one potential configuration setting.

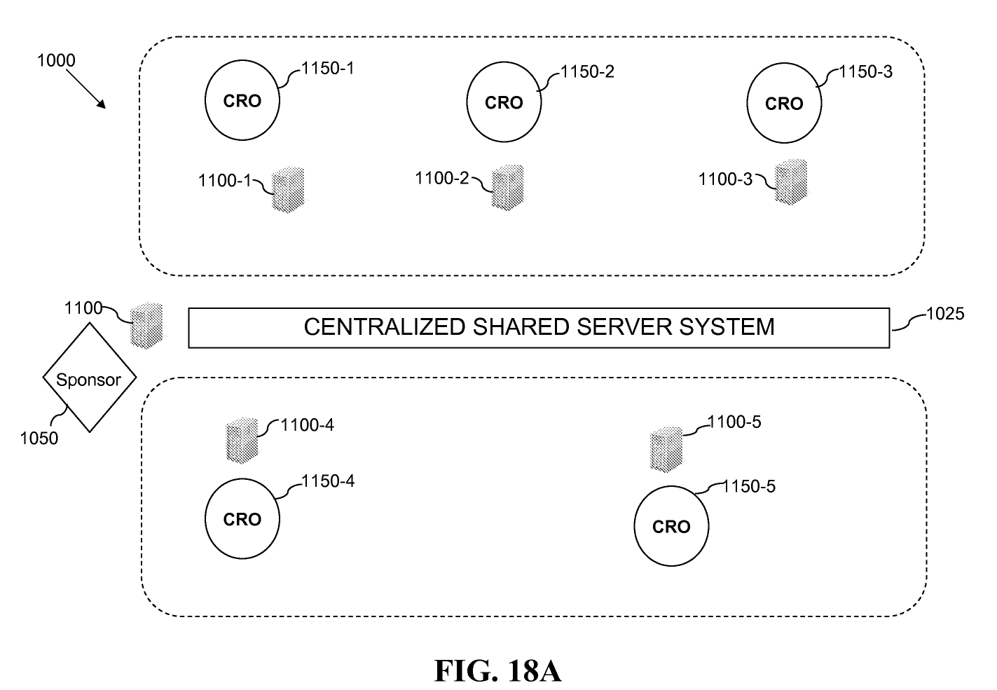

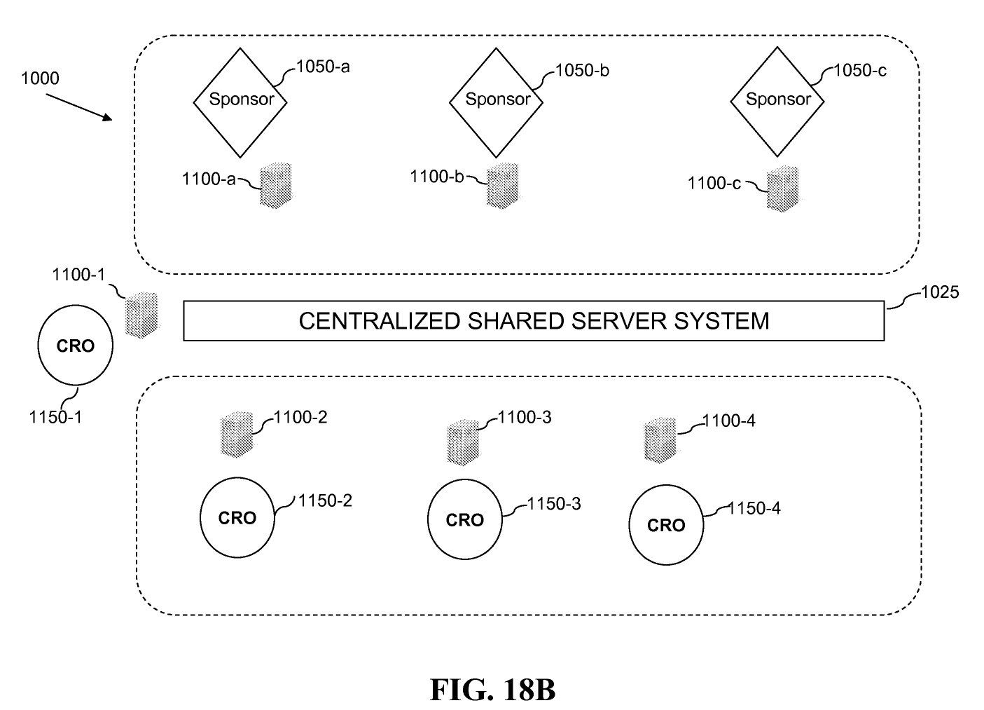

FIGS. 18A and 18B show examples of how the addition of the centralized shared server system 1025 manages a set of shared servers 1100 so that the centralized shared server system 1025 and the network of distributed shared servers 1100 together logically function as a virtual network 1000 through which a first connected clinical trial organization appears to have a direct physical connection to at least one second clinical trial organization's clinical trial data to which the first clinical trial organization has rights to access, as if the interconnection had been implemented through point-to-point integration. FIG. 18A (discussed below in more detail) shows the sponsor (as the exemplary first connected clinical trial organization) logical view of the sponsors' virtual network with a group of the sponsor's business partners. FIG. 18B (discussed below in more detail) shows a CRO (as the exemplary first connected clinical trial organization) logical view that includes the CRO's business partners. It should be noted, however, that FIGS. 18A and 18B are the same network (i.e. the virtual network, CROs, and other components are the same). Each connected clinical trial organization, however, can access the data to which it has rights.

FIG. 18A is an exemplary embodiment of a virtual network 1000 with a sponsor-centric focus. A sponsor 1050 may have several studies in progress that involve a different set of clinical trial organizations (shown as CROs 1150-1, 1150-2, 1150-3, 1150-4, and 1150-5). Therefore, network connections need to be established with the different set of CROs for each of the sponsor's several studies. As shown in FIG. 18A, the virtual network 1000 is created by connecting a centralized shared server system 1025 to shared servers 110 (shown as shared servers 1100, 1100-1, 1100-2, 1100-3, 110-4, and 1100-5) at the sponsor's site 1050 and at each of the CRO sites 1150-1, 1150-2, 1150-3, 1150-4, and 1150-5, respectively. It should be noted that a single centralized shared server system 1025 may support multiple independent virtual networks?

FIG. 18B similarly illustrates an exemplary embodiment of a virtual network 1000 with CRO-centric focus. In this shown embodiment, CRO 1150-1 connects with a plurality of clinical trial organizations (shown as a plurality of CROs and a plurality of sponsors). From the perspective of CRO 1150-1, CRO 1150-1 manages sponsors 1050-a, 1050-b, and 1050-c as well as other partner CROs 1150-2, 1150-3, and 1150-4 from a centralized environment (centralized shared server system 1025). Consequently, the shared servers 1100 (shown as 1100-1, 1100-2, 1100-3, 1100-4, 1100-a, 1100-b, and 1100-c) and the centralized shared server system 1025 form the central operational data hub (virtual network 1000) for interconnecting clinical and enterprise applications within the sponsor 1050 and CRO 1150 enterprises. This interconnection of the various clinical trial organizations (CROs 1150 and sponsors 1050) through use of the shared servers 1100 support situations in which two or more clinical trial organizations need to work together on a particular clinical trial.

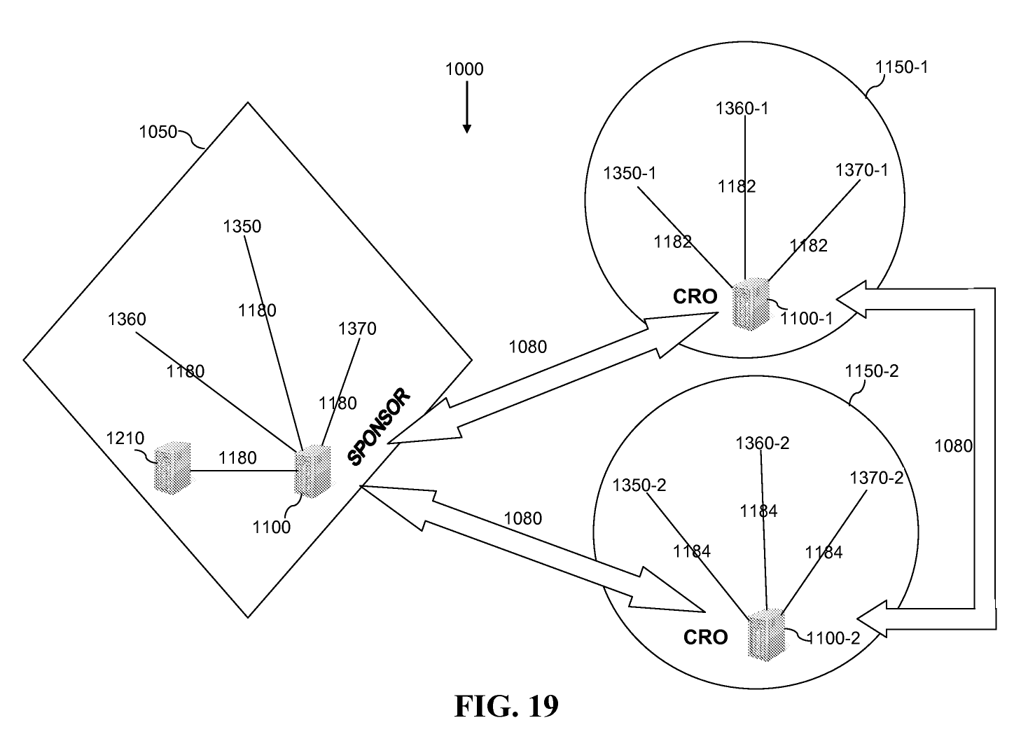

FIG. 19 illustrates an exemplary virtual network 1000 interconnecting a plurality of clinical trial organizations (shown as a sponsor 1050 and two CROs 1150-1 and 1150-2). The shared servers 1100-1 and 1100-2 of the CROs 1150-1 and 1150-2, respectively, are interconnected to the shared server 1100 of the sponsor 1050 by interfacing and communicating through any type of interface technology. The sponsor 1050 has clinical applications 1350, enterprise applications 1360, and customized applications 1370 connected to the shared server 1100 by interfacing and communicating through any type of interface technology (via data connections 1180). Using a shared server 1100-1 and data connection 1182, a first CRO 1150-1 may interconnect clinical applications 1350-1, enterprise applications 1360-1, and customized applications 1370-1. Using a shared server 1100-2 and data connection 1184, a second CRO 1150-2 may interconnect clinical applications 1350-2, enterprise applications 1360-2, and customized applications 1370-2. The communication directional arrows 1080 represent the virtual flow of data facilitated by the centralized shared server system 1025 (not shown in this figure). Data connections 1180, 1182, and 1184 are discussed above.

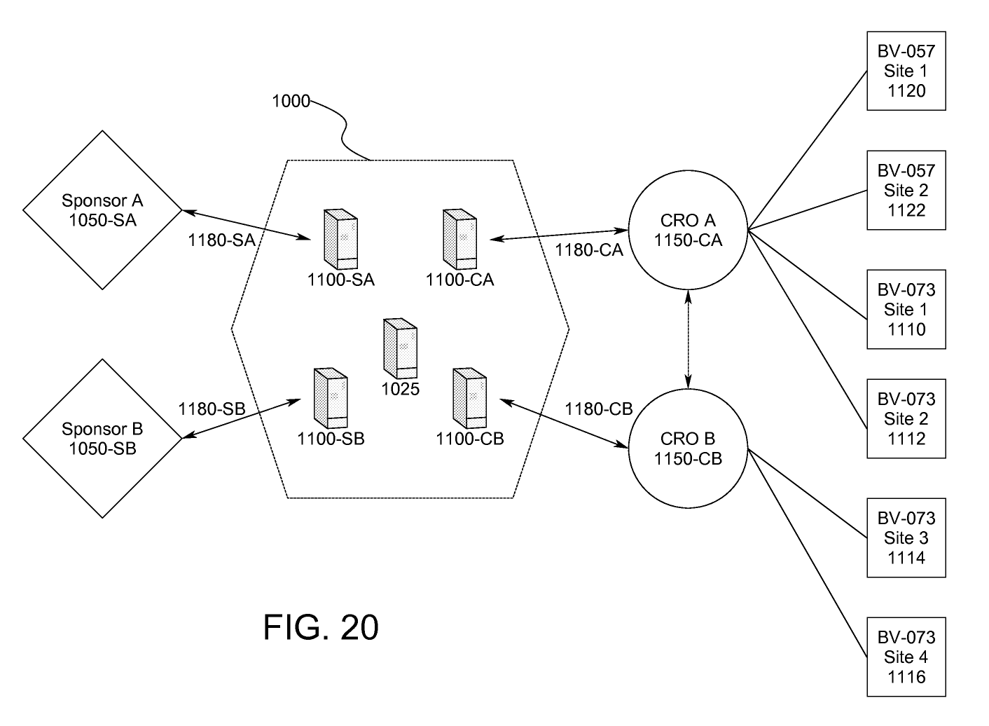

FIG. 20 is a schematic diagram depicting an exemplary configuration of a plurality of clinical trial organizations for exemplary clinical trial studies at different clinical sites that will be used as an example herein. This schematic diagram is not meant to be limiting in any way and may be applied to any number and combination of clinical trial organizations. Tables D-Q are exemplary tables relating to the example of FIG. 20. The actual table structures described can vary within different implementations using standard database design principles.

FIG. 20 shows the interrelationship between four exemplary clinical trial organizations: Sponsor A 1050-SA, Sponsor B 1050-SB, CRO A 1150-CA, and CRO B 1150-CB. Sponsor A 1050-SA, Sponsor B 1050-SB, CRO A 1150-CA, and CRO B 1150-CB are able to input data to and access their respective shared servers 1100 (1100-SA, 1100-SB, 1100-CA, and 1100-CB). All sponsors and CROs have connections between their respective shared servers 1100 and the centralized shared server system 1025 via data connections 1180 (1180-SA, 1180-SB, 1180-CA, and 1180-CB). Although each of Sponsor A, Sponsor B, CRO A, and CRO B has its own physical instance of the shared server 1100-SA, 1100-SB, 1100-CA, 1100-CB in FIG. 20, it should be noted that alternative configurations would use other distributed software methods (e.g. Software as a Service, commonly known as SaaS) or other similar methods to physically locate the shared server 1100 functionality in different locations and/or on combined hardware as long as the hardware is configured to provide virtual operation as independent shared servers 1100-SA, 1100-SB, 1100-CA, 1100-CB. Finally, FIG. 20 shows two exemplary clinical trials, “BV-073” (performed at four clinical sites 1110, 1112, 1114, and 1116) and “BV-057” (performed at two clinical sites 1120 and 1122).

For the “BV-073” clinical trial, Sponsor A 1050-SA contracts with CRO A 1150-CA. Sponsor A 1050-SA decides that they will perform site management functions involving selection and qualification of clinical sites. Sponsor A 1050-SA, however, decides to have CRO A 1150-CA perform the “subject screening” and “enrollment” functions for the four clinical sites 1110, 1112, 1114, and 1116 involved in the clinical trial of “BV-073.” CRO A 1150-CA decides to perform “subject screening” for the clinical “Site 1” 1110 and clinical “Site 2” 1112. Because in this example clinical “Site 3” 1114 and clinical “Site 4” 1116 are international sites, CRO A 1150-CA decides to subcontract to an international partner CRO B 1150-CB to handle the “subject screening.” This subcontracting relationship is shown in FIG. 20 by the dashed/phantom line between the two CROs. In this example, CRO A 1150-CA retains the responsibility to report the results to Sponsor A 1050-SA. In this example, CRO A 1150-CA is also managing both “site management” and “subject screening” as well as “enrollment” functions for another sponsor, Sponsor B 1050-SB on a different study “BV-057” involving sites 1120 and 1122

In this example, Sponsor A 1050-SA (as owner of the clinical trial of “BV-073”) has “read” access to all clinical trial information relating to “BV-073.” From the configuration user interface (e.g. as shown in FIG. 14), Sponsor A 1050-SA sets permission to allow CRO A 1150-CA to read or “Consume” all data fields within the “site management table” and to read/write or “Produce” the data fields applicable in the “subject screening” and “enrollment” table corresponding to the “clinical trial” and “site numbers” for which they will be involved. Sponsor A 1050-SA may use the configuration user interface of the centralized shared server system 1025 to establish a relationship so that CRO B 1150-CB can produce “subject enrollment” data for the clinical trial of “BV-073” on clinical “Site 3” 1114 and clinical “Site 4” 1116 while allowing CRO A 1150-CA to be responsible for producing “subject enrollment” data for clinical “Site 1” 1110, clinical “Site 2” 1112, clinical “Site 3” 1114, and clinical “Site 4” 1116, to recognize the subcontractor relationship. Since CRO A 1150-CA is subcontracting CRO B 1150-CB for certain duties, CRO A 1150-CA can view all data produced by CRO B 1150-CB and override any data, if necessary.

Table D represents a logical view of the information accessible through the centralized shared server system 1025 for the configuration shown in FIG. 20. In other words, Table D shows the permissions for management and synchronization of data between different clinical trial organizations. For example, a sponsor utilizes a user interface connected to the centralized shared server system 1025 to input information and assign data access rights. The sponsor assigns data access rights shown as “P” under the column heading of “Permission” that represents the right to produce data. The sponsor assigns data access rights shown as “C” under the column heading of “Permission” that represents the right to consume data. Assuming the exemplary configuration shown in FIG. 20 for the exemplary clinical trial of “BV-073,” Sponsor A 1050-SA may use the user interface of the centralized shared server system 1025 to assign the data access rights to CRO A that are reflected in the Table D by specifying the data access rights under the column heading of “Permission.” Sponsor A 1050-SA may then configure the synchronization period (not shown) by selecting a synchronization interval for the operational data that can be shared with and communicated to CRO A. Table D is generated in the shared server 1100-SA and viewable by Sponsor A 1050-SA.

TABLE D
Sponsor A Configuration Table

| | CRO A | | |
|---|---|---|---|
| | | Clinical | |
| | Permission | Trial | Site |
| Site Information | C | BV-073 | 1, 2, 3, 4 |
| Subject Screening Information | P | BV-073 | 1, 2, 3, 4 |

For the “BV-057” clinical trial, independent Sponsor B 1050-SB contracts with CRO A 1150-CA to perform a clinical trial at two clinical sites: clinical “Site 1” 1120 and clinical “Site 2” 1122. Sponsor B 1050-SB utilizes a user interface of the centralized shared server system 1025 to provide information and assign data access rights for the clinical trial of “BV-057.” Table E shows that Sponsor B 1050-SB has assigned CRO A 1150-CA data access rights shown as “P” (produce data) under the column heading of “Permission” for both “site information” and “subject screening information” at both clinical sites 1120 and 1122. Although not shown, Sponsor B 1050-SB may also specify a synchronization interval independent of Sponsor A's selection of its synchronization interval. Table E is generated in the shared server 1100-SB and viewable by Sponsor B 1050-SB.

TABLE E
SPONSOR B CONFIGURATION TABLE

CRO A

| | | Clinical | |
|---|---|---|---|
| | Permission | Trial | Site |
| Site Information | P | BV-057 | 1, 2 |
| Subject Screening Information | P | BV-057 | 1, 2 |

The data access rights under the “Permission” sections of Table D and Table E are communicated to the shared server 1100-CA of CRO A by synchronization via centralized shared server 1025, and the following exemplary Table F is produced within the shared server 1100-CA of CRO A.

TABLE F
CRO A CONFIGURATION TABLE

| | Permission | Clinical Trial | Site |
|---|---|---|---|
| | Sponsor A | | |
| Site Information | C | BV-073 | 1, 2, 3, 4 |
| Subject Screening Information | P | BV-073 | 1, 2, 3, 4 |
| | Sponsor B | | |
| Site Information | P | BV-057 | 1, 2 |
| Subject Screening Information | P | BV-057 | 1, 2 |

CRO A then utilizes the user interface of the centralized shared server system 1025 to assign data access rights (as shown under the “Permission” section of Table G) to CRO B for the subset of clinical data that CRO B can “produce” and “consume” within this particular clinical trial. CRO A may further select a synchronization interval (not shown). Table G is extended from the previous Table F to show data access rights for CRO B and is viewable by CRO A.

TABLE G
CRO A CONFIGURATION TABLE

| | Permission | Clinical Trial | Site |
|---|---|---|---|
| | Sponsor A | | |
| Site Information | C | BV-073 | 1, 2, 3, 4 |
| Subject Screening Information | P | BV-073 | 1, 2, 3, 4 |
| | Sponsor B | | |
| Site Information | P | BV-057 | 1, 2 |
| Subject Screening Information | P | BV-057 | 1, 2 |
| | CRO B | | |
| Site Information | C | BV-073 | 3, 4 |
| Subject Screening Information | P | BV-073 | 3, 4 |

At the next synchronization period, as defined by CRO A, the shared server 1100-CB of CRO B is automatically updated with the following data access rights information via centralized shared server 1025 for the clinical trial of “BV-073,” as illustrated in the exemplary Table H. Table H is viewable by CRO B and generated in CRO B's shared server 1100-CB.

TABLE H
CRO B CONFIGURATION TABLE

| | CRO A | | |
|---|---|---|---|
| | Permission | Clinical Trial | Site |
| Site Information | C | BV-073 | 3, 4 |
| Subject Screening Information | P | BV-073 | 3, 4 |

As a “Producer” of the “Site Information” data, Sponsor A 1050-SA may utilize its local CTMS or other clinical software to set up and qualify all four clinical sites (clinical “Site 1” 1110, clinical “Site 2” 1112, clinical “Site 3” 1114, and clinical “Site 4” 1116) for the “BV-073” clinical trial. The operational data is automatically updated (using, for example, a communications computer program) in the shared database 115, 1025 of the shared server 110, 1100-SA as previously described in relation to FIGS. 4-6 and 12. Sponsor B may also utilize its own local CTMS or other clinical software to set up and qualify its two clinical sites (clinical “Site 1” 1120 and clinical “Site 2” 1122) of the “BV-057” clinical trial. The operational data is automatically updated in shared server 1100-SB via centralized server 1025. The following exemplary Tables I and J illustrate “Site Information” data for Sponsors A and B that are retained within each of the sponsor's local shared servers 1100-SA, 1100-SB.

TABLE I
SITE INFORMATION - SPONSOR A

| Clinical | | | | | | |
|---|---|---|---|---|---|---|
| Trial | Site | Max | | | | |
| Number | Number | Subjects | Evaluation Date | Startup Date | Open Date | Activation Date |
| BV-073 | 1 | 50 | Mar. 27, 2008 | Apr. 2, 2008 | Apr. 8, 2008 | May 24, 2008 |
| BV-073 | 2 | 37 | Apr. 15, 2008 | Apr. 17, 2008 | Apr. 21, 2008 | May 15, 2008 |
| BV-073 | 3 | 25 | May 1, 2008 | May 1, 2008 | May 26, 2008 | Jun. 19, 2008 |
| BV-073 | 4 | 14 | Jun. 15, 2008 | Jun. 18, 2008 | Jul. 12, 2008 | Aug. 22, 2008 |

TABLE J
SITE INFORMATION - SPONSOR B

| Clinical | | | | | | |
|---|---|---|---|---|---|---|
| Trial | Site | Max | | | | |
| Number | Number | Subjects | Evaluation Date | Startup Date | Open Date | Activation Date |
| BV-057 | 1 | 54 | Jan. 5, 2009 | Jan. 8, 2009 | Jan. 27, 2009 | Mar. 13, 2009 |
| BV-057 | 2 | 27 | Feb. 14, 2009 | Feb. 20, 2009 | Mar. 17, 2009 | May 4, 2009 |

Upon synchronization (based on the defined synchronization intervals independently selected by Sponsors A and B), the “Site Information” data is transmitted between the centralized shared server system 1025 and CRO A's shared server 1100-CA. By communicating the “Site Information” data between the centralized shared server system 1025 and CRO A's shared server 1100-CA, the following consolidated information of Table K is established and created within CRO A's shared server 1100-CA.

TABLE K
SITE INFORMATION - CRO A

| Clinical | | | | | | |
|---|---|---|---|---|---|---|
| Trial | Site | Max | | | | |
| Number | Number | Subjects | Evaluation Date | Startup Date | Open Date | Activation Date |
| BV-073 | 1 | 50 | Mar. 27, 2008 | Mar. 27, 2008 | Apr. 1, 2008 | May 11, 2008 |
| BV-073 | 2 | 37 | Apr. 15, 2008 | Apr. 20, 2008 | May 14, 2008 | Jun. 8, 2008 |
| BV-073 | 3 | 25 | May 1, 2008 | May 1, 2008 | May 10, 2008 | Jun. 19, 2008 |
| BV-073 | 4 | 14 | Jun. 15, 2008 | Jun. 20, 2008 | Jun. 26, 2008 | Jul. 15, 2008 |
| BV-057 | 1 | 54 | Jan. 5, 2009 | Jan. 7, 2009 | Jan. 8, 2009 | Feb. 2, 2009 |
| BV-057 | 2 | 27 | Feb. 14, 2009 | Feb. 15, 2009 | Feb. 26, 2009 | Mar. 3, 2009 |

At the next synchronization interval as defined by CRO A for data available to CRO B, the following information in Table L is further transmitted to the shared server 1100-CB of CRO B via the centralized shared server system 1025.

TABLE L
SITE INFORMATION - CRO B

| Clinical | | | | | | |
|---|---|---|---|---|---|---|
| Trial | Site | Max | | | | |
| Number | Number | Subjects | Evaluation Date | Startup Date | Open Date | Activation Date |
| BV-073 | 3 | 25 | May 1, 2008 | May 1, 2008 | May 29, 2008 | Jun. 4, 2008 |
| BV-073 | 4 | 14 | Jun. 15, 2008 | Jun. 20, 2008 | Jul. 14, 2008 | Aug. 5, 2008 |

Upon synchronization at the defined synchronization interval, each clinical trial organization (e.g. Sponsor A, Sponsor B, CRO A, CRO B) has access to the “Site Information” data for which it has access rights based upon configuration tables D-H as previously established. Sponsor A, Sponsor B, CRO A, and CRO B can use any of their CTMS or other similar clinical software that are connected to each of the shared servers 1100-SA, 1100-SB, 1100-CA, 1100-CB to “produce” and/or “consume” data consistent with each of the assigned access rights for a particular clinical trial.

Updates to operational data “Produced” by any one of Sponsor A, Sponsor B, CRO A, or CRO B for which any can “Consume” are automatically updated in their respective shared servers 1100-SA, 1100-SB, 1100-CA, 1100-CB at the next synchronization point as previously defined by the synchronization interval. Based upon the “Site Information” data now available within the local shared servers 1100-SA, 1100-SB, 1100-CA, 1100-CB of the clinical trial organizations, CRO A and CRO B can start performing their assigned responsibility for patient screening and enrollment through each of its own clinical trial applications with the “produced” data readily accessible to other clinical trial organizations. Any other clinical trial organizations may perform assigned tasks based upon the permissions configured by Sponsor A, Sponsor B, CRO A, and/or CRO B through the centralized shared server system 1025 via input of data access rights from user interfaces. The assigned task of patient screening and enrollment can be conducted through verbal, electronic, or other similar communication means.

The following exemplary Tables M-P show the “Subject Information” data as viewed by Sponsor A, Sponsor B, CRO A, and CRO B, respectively. Upon synchronization facilitated by the centralized shared server system 1025 with shared servers 1100-SA, 1100-SB, 1100-CA, and 1100-CB, the “Subject Information” data as entered by the designated “producers” of the “Subject Information” data results in the following Tables M-P in each of the shared servers 1100 for Sponsor A, Sponsor B, CRO A, and CRO B.

TABLE M
SPONSOR A--SUBJECT INFORMATION TABLE

| Clinical | Site | Subject | Date Informed | Date Assent | Screening | Enrollment | Discontinuation | Screening |
|---|---|---|---|---|---|---|---|---|
| Trial No. | No. | No. | Consent Signed | Form Signed | Date | Date | Date | Passed |
| BV-073 | 1 | 1 | Jul. 2, 2008 | Jul. 12, 2008 | Jul. 21, 2008 | Aug. 1, 2008 | Aug. 21, 2008 | No |
| BV-073 | 1 | 2 | Sep. 18, 2008 | Aug. 4, 2008 | Oct. 6, 2008 | Dec. 18, 2008 | Jan. 4, 2009 | Yes |
| BV-073 | 1 | 3 | Dec. 1, 2008 | Sep. 8, 2008 | Sep. 28, 2008 | Dec. 1, 2008 | Feb. 9, 2009 | Yes |
| BV-073 | 1 | 4 | Jan. 6, 2009 | Oct. 10, 2008 | Oct. 15, 2008 | Nov. 20, 2008 | Jan. 10, 2009 | Yes |
| BV-073 | 2 | 1 | Jul. 20, 2008 | Aug. 19, 2008 | Sep. 11, 2008 | Oct. 8, 2008 | Oct. 31, 2008 | Yes |
| BV-073 | 2 | 2 | Oct. 15, 2008 | Nov. 2, 2008 | Dec. 23, 2008 | Jan. 14, 2009 | Feb. 1, 2009 | No |
| BV-073 | 2 | 3 | Oct. 25, 2008 | Nov. 3, 2008 | Jan. 8, 2009 | Feb. 23, 2009 | Mar. 3, 2009 | Yes |
| BV-073 | 3 | 1 | Jun. 24, 2008 | Jul. 8, 2008 | Aug. 4, 2008 | Aug. 19, 2008 | Sep. 16, 2008 | Yes |
| BV-073 | 3 | 2 | Sep. 15, 2008 | Jul. 21, 2008 | Aug. 23, 2008 | Oct. 13, 2008 | Nov. 17, 2008 | Yes |
| BV-073 | 4 | 1 | Aug. 27, 2008 | Sep. 7, 2008 | Sep. 8, 2008 | Sep. 9, 2008 | Sep. 14, 2008 | No |
| BV-073 | 4 | 2 | Nov. 8, 2008 | Oct. 21, 2008 | Dec. 15, 2008 | Feb. 9, 2009 | Mar. 16, 2009 | Yes |

TABLE N
SPONSOR B--SUBJECT INFORMATION TABLE

| Clinical | Site | Subject | Date Informed | Date Assent | Screening | Enrollment | Discontinuation | Screening |
|---|---|---|---|---|---|---|---|---|
| Trial No. | No. | No. | Consent Signed | Form Signed | Date | Date | Date | Passed |
| BV-057 | 1 | 1 | Feb. 6, 2009 | Mar. 5, 2009 | Mar. 29, 2009 | Apr. 11, 2009 | Apr. 20, 2009 | Yes |
| BV-057 | 1 | 2 | Mar. 7, 2009 | Mar. 31, 2009 | May 9, 2009 | Jul. 20, 2009 | Aug. 11, 2009 | Yes |
| BV-057 | 2 | 1 | Apr. 22, 2009 | Apr. 27, 2009 | May 6, 2009 | May 8, 2009 | May 30, 2009 | No |
| BV-057 | 2 | 2 | May 28, 2009 | Jul. 14, 2009 | May 27, 2009 | Jun. 26, 2009 | Aug. 18, 2009 | Yes |

Tables O-P show the “Subject Information” data for CRO A and CRO B, respectively, and are viewable by CRO A and CRO B accessed from each of the shared servers 1100-CA, 1100-CB.

TABLE O
CRO A SUBJECT INFORMATION TABLE

| Clinical | Site | Subject | Date Informed | Date Assent | | Enrollment | Discontinuation | Screening |
|---|---|---|---|---|---|---|---|---|
| Trial No. | No. | No. | Consent Signed | Form Signed | Screening Date | Date | Date | Passed |
| BV-073 | 1 | 1 | Jul. 6, 2008 | Jul. 20, 2008 | Jul. 23, 2008 | Aug. 19, 2008 | Sep. 10, 2008 | No |
| BV-073 | 1 | 2 | Aug. 1, 2008 | Sep. 8, 2008 | Oct. 13, 2008 | Dec. 27, 2008 | Mar. 15, 2009 | Yes |
| BV-073 | 1 | 3 | Oct. 6, 2008 | Oct. 18, 2008 | Dec. 11, 2008 | Jan. 8, 2009 | Mar. 28, 2009 | Yes |
| BV-073 | 1 | 4 | Oct. 20, 2008 | Nov. 14, 2008 | Jan. 30, 2009 | Mar. 30, 2009 | Jun. 22, 2009 | Yes |
| BV-073 | 2 | 1 | May 23, 2008 | May 23, 2008 | Jun. 17, 2008 | Jun. 24, 2008 | Jul. 11, 2008 | Yes |
| BV-073 | 2 | 2 | Jun. 13, 2008 | Jul. 7, 2008 | Sep. 29, 2008 | Nov. 28, 2008 | Dec. 13, 2008 | No |
| BV-073 | 2 | 3 | Aug. 30, 2008 | Aug. 8, 2008 | Aug. 20, 2008 | Oct. 4, 2008 | Dec. 23, 2008 | Yes |
| BV-073 | 3 | 1 | Jun. 10, 2008 | Jul. 5, 2008 | Jul. 10, 2008 | Jul. 12, 2008 | Jul. 28, 2008 | Yes |
| BV-073 | 3 | 2 | Aug. 11, 2008 | Aug. 1, 2008 | Aug. 16, 2008 | Oct. 26, 2008 | Dec. 30, 2008 | Yes |
| BV-073 | 4 | 1 | Jul. 26, 2008 | Jul. 27, 2008 | Jul. 30, 2008 | Aug. 23, 2008 | Aug. 25, 2008 | No |
| BV-073 | 4 | 2 | Oct. 3, 2008 | Sep. 2, 2008 | Oct. 8, 2008 | Nov. 17, 2008 | Jan. 1, 2009 | Yes |
| BV-057 | 1 | 1 | Jan. 27, 2009 | Feb. 14, 2009 | Mar. 10, 2009 | Apr. 9, 2009 | May 5, 2009 | Yes |
| BV-057 | 1 | 2 | Feb. 17, 2009 | Apr. 3, 2009 | Apr. 19, 2009 | Apr. 28, 2009 | Jul. 19, 2009 | Yes |
| BV-057 | 2 | 1 | May 16, 2009 | Jun. 3, 2009 | Jun. 12, 2009 | Jun. 29, 2009 | Jul. 25, 2009 | No |

TABLE P
CRO B SUBJECT INFORMATION TABLE

| Clinical | Site | Subject | Date Informed | Date Assent | | Enrollment | Discontinuation | Screening |
|---|---|---|---|---|---|---|---|---|
| Trial No. | No. | No. | Consent Signed | Form Signed | Screening Date | Date | Date | Passed |
| BV-073 | 3 | 1 | Jun. 24, 2008 | Jul. 15, 2008 | Aug. 13, 2008 | Sep. 5, 2008 | Sep. 22, 2008 | Yes |
| BV-073 | 3 | 2 | Sep. 15, 2008 | Aug. 22, 2008 | Oct. 16, 2008 | Jan. 4, 2009 | Jan. 20, 2009 | Yes |

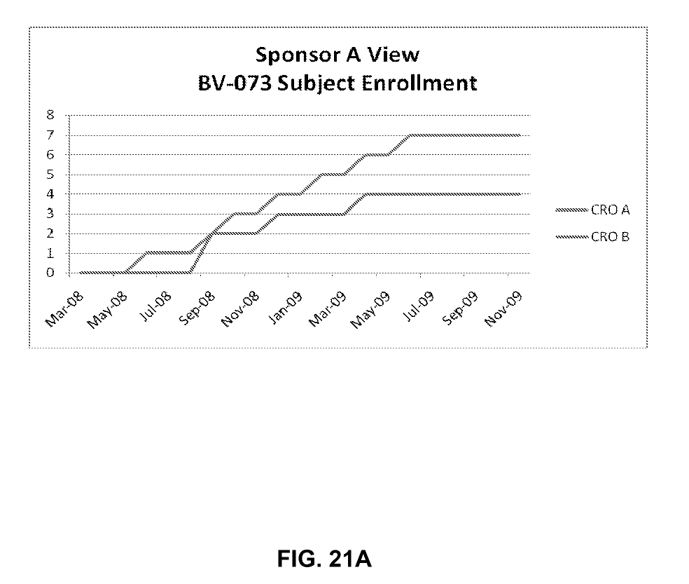

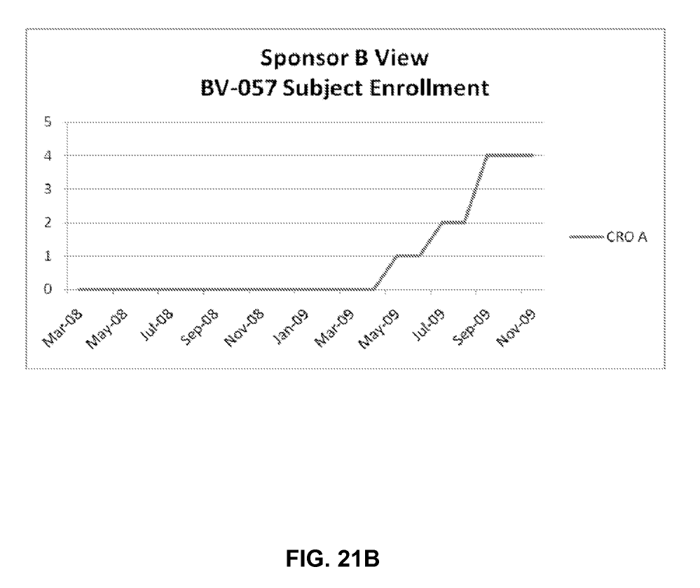

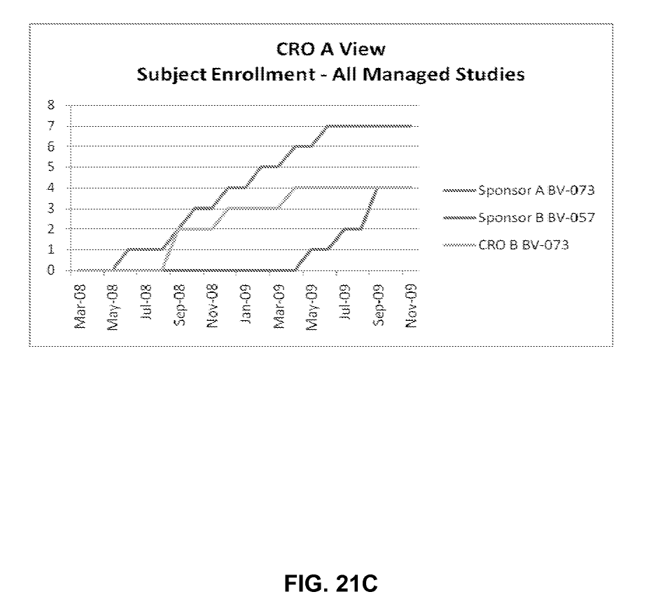

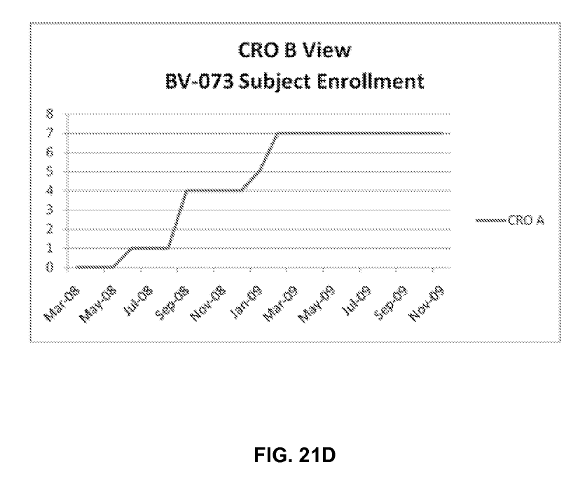

FIGS. 21A-D are exemplary charts for subject enrollment data. The exemplary subject enrollment data can be easily generated independently by Sponsor A, Sponsor B, CRO A, or CRO B within their own CTMS or other similar software connected to each of the local shared server 1100-SA, 1100-SB, 1100-CA, and 1100-CB. FIG. 21A is Sponsor A's view of the number of subject enrollment for CRO A and CRO B for the “BV-073” clinical trial from March of 2008 to November of 2009. FIG. 21B is Sponsor B's view of the number of subject enrollment for CRO A for the “BV-057” clinical trial from March of 2008 to November of 2009. FIG. 21C is CRO A's view of the number of subject enrollment for Sponsor A, Sponsor B and CRO B for the “BV-073” and “BV-057” studies from March 2008 to November 2009. FIG. 21D is CRO B′s view of the number of subject enrollment for CRO A for the “BV-073” clinical trial from March 2008 to November 2009.

CRO A may view the “Subject Enrollment” data via the shared server 1100-SA and, based upon the subject enrollment chart as shown in FIG. 21C, determine that CRO B is not meeting patient recruitment goals. CRO A may then decide to hire a different international CRO to take over recruitment at the clinical sites assigned to CRO B (i.e. clinical “Site 3” 1114 to CRO C and clinical “Site 4” 1116 for the “BV-073” clinical trial). By accessing the centralized shared server system 1025 via a user interface, CRO A can change the permissions required to terminate CRO B′s access for information and add a new CRO C (not shown) with the same permissions previously held by CRO B. For example, CRO A can assign clinical “Site 3” 1114 to CRO C and clinical “Site 4” 1116 to another CRO (e.g. CRO D). In this particular example, CRO C would have the same data view as previously accessed by CRO B, and CRO C may start managing the “subject enrollment” data or other accessible data through its own clinical trial applications. Even though other physical steps such as site evaluation, contract signing, etc. are necessary outside of transmission and synching of data, any newly updated responsibilities by new or old clinical trial organizations are easily modified and updated by the use of the centralized shared server system 1025.

The centralized shared server system 1025 allows the shared database system to not only have a centralized database for clinical data exchange for clinical trial organizations but also allows a network of distributed databases of the shared servers 110, 1110 to act as a centralized database for clinical data exchange. The virtual network 1000 created by the centralized shared server system 1025 enables sponsors, CROs, clinical sites and other clinical trial organizations to easily maintain overall control of the clinical trial studies in this “functional outsourcing model.” Further, clinical trial organizations may allocate specific permissions and responsibilities to other clinical trial organizations in this “selective outsourcing model” since functions and sites can be assigned. Table Q illustrates exemplary responsibilities that are allocated by the sponsor across three different CROs for specific clinical trial studies:

TABLE O

| | SPONSOR | CRO1 | CRO2 | CRO3 |
|---|---|---|---|---|
| CTM | | | | |
| Site Management | X | | | |
| Site Monitoring | | X | X | X |
| CRF Tracking and | | X | X | X |
| Verification | | | | |
| Subject Management | | X | X | X |
| Shipment Tracking | X | | | |
| Document Management | | | | |
| CPM | | | | |
| Site Payment | X | | | |
| Common Clinical | | | | |
| Trial Functions | | | | |
| Contact Management | X | X | X | |
| Clinical Trial Setup | X | | | |

In Table Q, the sponsor is retaining responsibility for “Site Payments” but is assigning other CROs to each manage more labor intensive functions such as “Site Monitoring,” “CRF Tracking and Verification,” and “Subject Management.”

It should be noted that the system described herein may be implemented using different types of devices, including but not limited to hardware such as computers (or other programmable apparatuses), workstations, handheld technical devices (e.g. Pocket PC® devices, Palm® devices), interactive televisions, kiosks, dedicated devices, processors (or groups of processors), general purpose devices, dedicated purpose devices, or virtually any known or future interactive technology device means, all of which are referred to in this specification as “hardware” and/or “computers.” It should be noted that a method of the present invention may be a computer program or application encoded and/or stored on a computer/machine (or other device)-readable medium or tangible media (computer-readable storage medium) including, but not limited to, RAM, ROM, floppy disks, hard disks, or virtually any known or future memory and/or storage means, all of which are referred to in this specification as “memory.” It should be noted that the present invention may be implemented using or functioning on operating systems, including, but not limited to, Windows Vista®, Windows 95®, Windows 98®, Windows CE®, Windows Me®, Windows NT®, Windows2000®, Linux®, MacOS®, BeOS®, or virtually any known or future operating system means, all of which are referred to in this specification as “operating systems.” It should be noted that the present invention may be implemented or programmed using languages including, but not limited to, C, C++, Turbo C, Fortran, Pascal, ADA, Java™ language, JavaScript®, Java Applet™ technology, Perl®, Smalltalk®, assembly language, HTML (Hypertext Markup Language), DHTML (Dynamic Hypertext Markup Language), XML (eXtensible Markup Language), XLS (eXtensible Style Language), SVG (Scalable Vector Graphics), VML (Vector Markup Language), Macromedia's Flash™ technology, or virtually any known or future programming language means, all of which are referred to in this specification as “programming languages.” In any case, the programming language may be a compiled or interpreted language, and combined with hardware implementations. Further, various programming approaches such as procedural, object-oriented, or artificial intelligence techniques may be employed, depending on the requirements of each particular implementation. Finally, it should be noted that the term “software” is meant to include individual programs (i.e. computer implemented series of instructions, computer program instructions, and/or computer-readable program code), combinations of programs, and/or sub-programs that are implemented in any programming language and/or for any operating system. The “software” may be encoded and/or stored on one or more computer/machine (or other device)-readable medium or tangible media.

It should be further noted that although the present invention is described in terms of data connections, the terms are not meant to be limiting. The terms “transmit” and “transmitting” are meant to include standard means of provision but can also be used for non-traditional provisions as long as the data is “sent” or “received” (that can also mean obtained). The methods and apparatus of the present invention may also be practiced via communications embodied in the form of program code that is transmitted over some transmission medium, such as over electrical wiring or cabling, through fiber optics, or via any other form of transmission, wherein when the program code is received and loaded into and executed by a machine, the machine becomes an apparatus for practicing the invention.

The terms “computer program,” “computer application,” and “software application” are used substantially synonymously (although a computer program may encompass multiple computer or software applications). In most cases, the term “application” may be understood from context to mean that the application is implemented as a “software” application (e.g. shared server interacting applications, clinical trial-related applications, and clinical applications are implemented as software applications). Computer programs are implemented using executable instructions that are stored in memory and executable by a processor, computer, and/or server. When implemented on a general-purpose processor, the program code combines with the processor to provide a unique apparatus that operates to invoke the functionality of the present invention. Additionally, any storage techniques used in connection with this present invention may invariably be a combination of hardware and software.

Thus, the present invention is presently embodied as methods, systems, computer program products or computer readable mediums encoding computer programs for sharing and integrating operational data.

### Source Code

Code.txt is a source code for an exemplary program as described above, which contains the following software components: Part A, Part B, Part C, Part D, and Part E. These software components are included on the two identical CDs that are submitted with this application, and the material on the CDs is incorporated into this specification by reference in its entirety.

All the references cited herein are incorporated by reference.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A method for exchanging clinical trial operational data among a plurality of clinical trial organizations using a plurality of shared servers connected to a centralized shared server system of a shared database system, comprising:
allowing a first clinical trial organization to access the centralized shared server system;
receiving from the first clinical trial organization an assignment of data access rights associated with at least one clinical trial operational data to at least one other clinical trial organization for at least one clinical trial from the centralized shared server system;
generating at least one table with the assigned data access rights associated with the at least one clinical trial operational data for the at least one clinical trial in a first shared server;
communicating the assigned data access rights associated with the at least one clinical trial operational data for the at least one clinical trial to the at least one other clinical trial organization; and
allowing the at least one other clinical trial organization to access the at least one table associated with the at least one clinical trial operational data, the access limited by the assigned data access rights;
wherein the shared database system continuously provides updated clinical trial operational data accessible by any of the at least one other clinical trial organization from associated at least one shared server in accordance with the assigned data access rights associated with the at least one clinical trial operational data.

2. The method of claim 1, further comprising the step of automatically synchronizing the at least one clinical trial operational data based on common data definitions based on the data access rights associated with the clinical trial operational data within the plurality of shared servers.

3. The method of claim 1, wherein the step of allowing a first clinical trial organization to access the centralized shared server system comprises the steps of:
providing a configuration user interface of the centralized shared server system; and
receiving the data access rights associated with the at least one clinical trial operational data from the configuration user interface.

4. The method of claim 1, wherein the step of receiving from the first clinical trial organization an assignment of data access rights associated with at least one clinical trial operational data to at least one other clinical trial organization for at least one clinical trial from the centralized shared server system further comprising configuring the at least one other clinical trial organization according to the assignment of data access rights as either a producer or a consumer of the clinical trial operational data for limiting access to the at least one table with the clinical trial operational data by the at least one other clinical trial organization.

5. The method of claim 1, wherein the step of generating the at least one table with the assigned data access rights associated with the at least one clinical trial operational data comprises:
sending the assigned data access rights associated with the at least one clinical trial operational data to the first shared server; and
displaying at least one table view on a user interface of the assigned data access rights associated with the at least one clinical trial operational data of the at least one other clinical trial organization in the first shared server.

6. The method of claim 1, wherein the step of communicating the assigned data access rights associated with the at least one clinical trial operational data for the at least one clinical trial to the at least one other clinical trial organizations further comprises continuously synchronizing the centralized shared server system with the plurality of shared servers of the plurality clinical trial organizations based on a synchronization interval configured with any updated assigned data access rights associated with the at least one clinical trial operational data for the at least one clinical trial.

7. The method of claim 1, further comprising the step of managing the clinical trial operational data from the plurality of shared servers limited to the assigned data access rights by interacting with at least one shared server interacting application selected from the group consisting of: Clinical Trial Management Systems, Clinical Data Management System, Electronic Data Capture, Clinical Trial Manager, Clinical Payment Manager, Laboratory Information Management Systems, Interactive Voice Response Systems, Safety Applications, eSubmission Applications, eDiary Applications, Medical Imaging Applications, other applications designed to be used in clinical trials, Statistical Analysis Systems, Customer Relationship Management, Personal Information Management System, Enterprise Resource Planning System, Manufacturing Execution Systems, financial and accounting systems, customized applications for clinical trials, and other business applications.

8. A shared database system for exchanging clinical trial operational data using a plurality of shared servers connected to a centralized shared server system, the shared database system comprising:
a synchronizing computer application stored in a computer-readable storage medium of the centralized shared server system, the synchronizing computer application for synchronizing the clinical trial operational data between the centralized shared server system and the plurality of shared servers;
a plurality of shared databases stored in a computer-readable storage medium of at least one of the plurality of shared servers, each shared database having a plurality of tables stored therein, wherein each table of the plurality of tables is organized by the clinical trial operational data and each table of the plurality of tables contains predefined data field identifiers associated with the clinical trial operational data for at least one clinical trial; and
a communications computer program stored in a computer-readable storage medium of at least one of the plurality of shared servers, the communications computer program being in communication with a plurality of shared server interacting applications to update the clinical trial operational data associated with the predefined data field identifiers for the at least one clinical trial in the plurality of tables.

9. The shared database system of claim 8, each shared server interacting application being a shared server interacting applications selected from the group consisting of: Clinical Trial Management Systems, Clinical Data Management System, Electronic Data Capture, Clinical Trial Manager, Clinical Payment Manager, Laboratory Information Management Systems, Interactive Voice Response Systems, Safety Applications, eSubmission Applications, eDiary Applications, Medical Imaging Applications, other applications designed to be used in clinical trials, Statistical Analysis Systems, Customer Relationship Management, Personal Information Management System, Enterprise Resource Planning System, Manufacturing Execution Systems, financial and accounting systems, customized applications for clinical trials, and other business applications.

10. The shared database system of claim 8, the synchronizing computer application being accessible via a configuration user interface for configuring data access rights of at least one other clinical trial organization as either a producer or a consumer of the clinical trial operational data for limiting access to the clinical trial operational data.

11. The shared database system of claim 10, wherein the configuration user interface allows configuring a synchronization interval for synchronizing the clinical trial operational data associated with the data access rights with the plurality of shared servers.

12. The shared database system of claim 8, wherein each table of the plurality of tables contains the predefined data field identifiers in a column headings portion and the clinical trial operational data are in rows that are populated under the predefined data field identifiers for the at least one clinical trial.

13. The shared database system of claim 8, the communications computer program associates each of the clinical trial operational data with the predefined data field identifiers within a table, wherein manipulation of clinical trial operational data is selected from the group consisting of addition, deletion, and modification of rows under the predefined data field identifiers within the table.

14. A shared database system for exchanging clinical trial operational data using a plurality of shared servers connected to a centralized shared server system, the plurality of shared servers connected to a plurality of linked server interacting applications via a plurality of linked servers connected to the plurality of shared servers, the shared database system comprising:
a synchronizing computer application stored in a computer-readable storage medium of the centralized shared server system, the synchronizing computer application for synchronizing the clinical trial operational data between the centralized shared server system and the plurality of shared servers;
a shared database stored in a computer-readable storage medium of at least one of the plurality of shared servers, the shared database having a plurality of tables wherein each table of the plurality of tables is organized by a plurality of clinical trial operational data and each table has predefined data field identifiers associated with the plurality of clinical trial operational data;
a communications computer program in the shared server for executing instructions to synchronize with at least one linked server;
a linked server database in the linked server for storing the plurality of tables with the plurality of clinical trial operational data received from the shared server after synchronization;
a linked server computer program in the linked server for executing instructions to synchronize with the shared server; and
a configuration user interface for a plurality of clinical trial organizations to set configuration parameters between the centralized shared server system and at least one of the plurality of shared servers.

15. The shared database system of claim 14, a linked server interacting application is at least one of the plurality of linked server interacting applications selected from the group consisting of: Clinical Trial Management Systems, Clinical Data Management System, Electronic Data Capture, Clinical Trial Manager, Clinical Payment Manager, Laboratory Information Management Systems, Interactive Voice Response Systems, Safety Applications, eSubmission Applications, eDiary Applications, Medical Imaging Applications, other applications designed to be used in clinical trials, Statistical Analysis Systems, Customer Relationship Management, Personal Information Management System, Enterprise Resource Planning System, Manufacturing Execution Systems, financial and accounting systems, customized applications for clinical trials, and other business applications.

16. The shared database system of claim 14, wherein the computer program in the shared server includes an access module for sending, receiving, and updating the plurality of tables with at least one change in clinical trial operational data associated with the data access rights.

17. The shared database system of claim 14, wherein the configuration user interface allows configuring data access rights of at least one other clinical trial organization as either a producer or a consumer of the clinical trial operational data for limiting access to the clinical trial operational data.

18. The shared database system of claim 14, wherein the configuration user interface allows configuring a synchronization interval for synchronizing the clinical trial operational data associated with the data access rights with the plurality of shared servers.

19. A computer-readable storage medium having executable instructions written as computer-readable program code thereon for causing a centralized shared server system to exchange clinical trial operational data with a plurality of shared servers connected to a plurality of shared server interacting applications, the executable instructions for causing the centralized shared server system to:
connect with the plurality of shared servers;
assign data access rights associated with at least one clinical trial operational data to at least one other user, the data access rights and the clinical trial operational data being input by a first user using a shared server to interact with a configuration user interface of the centralized shared server system;
update at least one table in a shared database with the data access rights associated with the at least one clinical trial operational data in the shared server of the first user;
send the assigned data access rights associated with the at least one clinical trial operational data to the plurality of shared servers connected to the plurality of shared server interacting applications; and
store at least one table in the shared database with at least one change in the clinical trial operational data in the shared server;
wherein a shared database system provides updates of the data access rights associated with the at least one clinical trial operational data input by at least one other user from the centralized shared server system to the plurality of shared servers.

20. The computer-readable storage medium of claim 19, the executable instructions for causing the centralized shared server system to assign data access rights further causing the centralized shared server system to configure the plurality of shared servers for the at least one other user as a producer or a consumer of the clinical trial operational data for limiting access to the clinical trial operational data.

21. The computer-readable storage medium of claim 19, the executable instructions for causing the centralized shared server system to exchange the clinical trial operational data updated by the plurality of shared server interacting applications with the plurality of shared servers.

22. The computer-readable storage medium of claim 19, the executable instructions for causing the centralized shared server system to configure the plurality of shared servers interacting with at least one other clinical trial operational data as a producer or a consumer of the clinical trial operational data to limit access to the plurality of clinical trial operational data.

23. The computer-readable storage medium of claim 19, the executable instructions for causing the centralized shared server system to provide a central operational data hub with information in a readily accessible format from the perspective of each clinical trial organization.

24. The computer-readable storage medium of claim 19, the executable instructions for causing the centralized shared server system to delegate responsibility to other users for producing subsets of clinical trial operational data with limited data access rights.

25. A centralized shared server system of a shared database system for exchanging clinical trial operational data among a plurality of clinical trial organizations, each clinical trial organization using at least one shared server, the centralized shared server system comprising:
the centralized shared server system for receiving from a first clinical trial organization an assignment of data access rights associated with at least one clinical trial operational data to at least one other clinical trial organization for at least one clinical trial;
the centralized shared server system for generating at least one table with the assigned data access rights associated with the at least one clinical trial operational data for the at least one clinical trial in a first shared server;
the centralized shared server system for communicating the assigned data access rights associated with the at least one clinical trial operational data for the at least one clinical trial to the at least one other clinical trial organization; and
the centralized shared server system for allowing the at least one other clinical trial organization to access the at least one table associated with the at least one clinical trial operational data, the access limited by the assigned data access rights;
wherein the shared database system continuously provides updated clinical trial operational data accessible by any of the at least one other clinical trial organization from associated at least one shared server in accordance with the assigned data access rights associated with the at least one clinical trial operational data.
